(19) United States
(12) Patent Application Publication
(10) Pub. No.: US 2017/0001885 A1
(43) Pub. Date: Jan. 5, 2017

(54) A DECALCIFYING APPARATUS

(71) Applicant: KONINKLIJKE PHILIPS N.V., Eindhoven (NL)

(72) Inventor: ALWIN ROGIER MARTIJN VERSCHUEREN, EINDHOVEN (NL)

(21) Appl. No.: 15/113,093

(22) PCT Filed: Feb. 5, 2015
(86) PCT No.: PCT/EP2015/052348

§ 371 Date: Jul. 21, 2016

(30) Foreign Application Priority Data
Feb. 6, 2014 (EP) 14154055.9

(51) Int. Cl. C02F 1/46; C02F 1/469; C02F 1/461

(52) U.S. Cl. CPC C02F 1/4602; C02F 1/46109; C02F 1/4691; C02F 2307/04; C02F 2101/20

(57) ABSTRACT

The present application relates to a decalcifying apparatus (20) for decalcifying an aqueous solution. The decalcifying apparatus (20) has an electrolytic cell section (26) configured to receive an aqueous solution. The electrolytic cell section has a first electrode arrangement (27) and a second electrode arrangement (28), and an ion generating body (41), such as a water-splitting membrane or an interposed electrolytic electrode. The ion generating body (41) is interposed in the electrolytic cell section in the second operating condition. The decalcifying apparatus (20) is configured to operate in a first operating condition for removing ions from aqueous solution, and a second operating condition for regenerating the ions into aqueous solution, the latter for example by reversing the potentials. The present invention also relates to a domestic appliance comprising the decalcifying apparatus and a method of decalcifying an aqueous solution employing the apparatus (20).

### FIELD OF THE INVENTION

The present invention relates to a decalcifying apparatus. In particular, the present invention relates to a decalcifying apparatus for decalcifying an aqueous solution. The present invention also relates to a domestic appliance comprising a decalcifying apparatus, and a method of decalcifying an aqueous solution.

### BACKGROUND OF THE INVENTION

Scale formation, also known as calcification, is an issue in many household appliances that use water, in particular hard tap water. Repeated use of these household appliances causes a build up of scale which can dramatically reduce the efficiency or quality of the function provided by the appliance. To avoid this reduced functionality and prevent malfunction, regular cleaning is required to remove the scales, also known as descaling, decalcifying or decalcification.

Consequences of failing to descale devices may include, for example, formation of scale in coffee makers blocking the fluid flow or insulating the heating element. In steam irons scaling may lead to brownish coloured water being spat onto garments. Furthermore, hard tap water used in air humidifiers based on ultrasonic transducers may spread white scaling dust.

It is known to provide a decalcifying apparatus with disposable cartridges, for example by means of ion exchange resins. Ion exchange resins decalcify water by substituting calcium and magnesium ions with sodium or potassium ions. However, the resins replace calcium and magnesium ions in water with sodium ions, which makes the treated water very sodium rich. Sodium rich water is generally not suitable for making tea, soy milk or diluting powder baby milk.

Alternatively, electrosorption may be used to treat water. Positive ions (for example, calcium) and negative ions (for example, bicarbonate) are captured by electrodes driven by an electric potential applied between both electrodes.

EP2402289 describes a hot water supply apparatus according to the present invention has water-softening means including at least a pair of electrodes and, a pair of water-splitting ion exchangers each having a positive ion exchanger and a negative ion exchanger, a flow path which is in contact with the water-splitting ion exchangers, and an inlet and an outlet which are in communication with the flow path, and heated hot water is guided into the water-softening means. Maintenance of the apparatus is unnecessary, a configuration of the apparatus is simple, the apparatus can be reduced in size, and the apparatus can softens raw water having high hardness and restore with low power consumption.

US2004231976 describes an arrangement for electrochemical purification or treatment of a liquid, utilizing an electrochemical cell, where two electrodes are provided with ion exchange membranes arranged between them to delimit a plurality of channels. According to the invention, at least a few channels have respective second electrodes (+,−) associated to them for obtaining a cleaning substance or solution, the latter being apt to dissolve and/or remove likely residuals and/or scaling deposited inside the cell.

U.S. Pat. No. 5,788,826 describes an electrochemical cell for removing ions from a solution stream comprises a housing having first and second electrodes. At least one water-splitting ion exchange membrane is positioned between the electrodes, the water-splitting membrane comprising (i) a cation exchange surface facing the first electrode, and (ii) an anion exchange surface facing the second electrode. A solution stream pathway is defined by the water-splitting membrane. The solution stream pathway comprises (i) an inlet for influent solution stream, (ii) at least one channel that allows influent solution stream to flow past at least one surface of the water-splitting membrane to form one or more treated solution streams, and (iii) a single outlet that combines the treated solution streams to form a single effluent solution. Preferably, the solution stream pathway comprises a unitary and contiguous channel that flows past both the cation and anion exchange surfaces of the water-splitting membrane, and more preferably is connected throughout in an unbroken sequence and extends substantially continuously from the inlet to the outlet.

US2005029124 describes an apparatus to treat an influent solution comprising ions to obtain a selectable ion concentration in an effluent solution. The apparatus comprises an electrochemical cell comprising a housing comprising first and second electrodes. A water-splitting ion exchange membrane is between the first and second electrodes, the membrane comprising ananion exchange surface facing the first electrode, and an cation exchange surface facing the second electrode, or vice versa. The housing also has an influent solution inlet and an effluent solution outlet with a solution channel that allows influent solution to flow past both the anion and cation exchange surfaces of the water-splitting ion exchange membrane to form the effluent solution. A variable voltage supply is capable of maintaining the first and second electrodes at a plurality of different voltages during an ion exchange stage.

### SUMMARY OF THE INVENTION

It is an object of the invention to provide an apparatus and method for decalcifying an aqueous solution which substantially alleviates or overcomes the problems mentioned above.

The invention is defined by the independent claims; the dependent claims define advantageous embodiments.

According to one aspect of the present invention, there is provided a decalcifying apparatus (herein also indicated as “apparatus”) for decalcifying an aqueous solution (such as (tap) water) comprising an electrolytic cell section configured to receive aqueous solution, the electrolytic cell section comprising a first electrode arrangement and a second electrode arrangement, especially wherein the first electrode arrangement comprises a first electrosorption electrode and wherein the second electrode arrangement comprises a second electrosorption electrode, and an ion generating body, especially wherein the ion generating body is not electrically connected (“floating electrode” in the case of an electrode), with the decalcifying apparatus being configured to operate in a first operating condition for removing ions from aqueous solution, and the decalcifying apparatus being configured to operate in a second operating condition for regenerating the ions into aqueous solution, wherein the ion generating body is interposed in the electrolytic cell section in the second operating condition.

Therefore, it is possible for the ion generating body to generate ions, hydrogen cations and hydroxide anions, to balance the charge of the ions regenerated from both first and second electrode arrangements. The ion generating body may also be able to act to substantially block recombination between regenerated ions from first and second electrode arrangements inside the electrolytic cell during the second operating condition.

Hence, in a specific embodiment the ion generating body is configured to generate (during use) hydrogen cations and hydroxide anions, to balance the charge of the ions regenerated from both first and second electrode arrangements, and wherein the ion generating body is configured to block recombination between regenerated ions from first and second electrode arrangements inside the electrolytic cell during the second operating condition.

With this arrangement it is possible to help providing simple and efficient decalcification of an aqueous solution, for example in a household appliance. Therefore, the formation of scale in an apparatus is minimised and so the performance of an appliance may be enhanced and its operational lifetime increased.

Herein, the term “first electrode arrangement”, “second electrode arrangement”, “first electrosorption electrode”, and “second electrosorption electrode”, etc., may each independently also refer to a plurality of first electrode arrangements, second electrode arrangements, first electrosorption electrodes, and second electrosorption electrodes, etc.

Especially, in an embodiment the decalcifying apparatus is configured to operate the first operation condition and the second operation condition one or more of (a) spatially and (b) temporarily separated from each other. This may imply that the decalcifying apparatus and/or the decalcifying method may be used and executed (respectively) in a batch-type process and in a continuous-type process. Hence, the first operation condition and the second operation condition may be executed consecutively with the same electrolytic cell unit, but may optionally also be executed at the same time when using two or more electrolytic cell units. Therefore, an apparatus with a single electrolytic cell unit will in general be applied batch wise (purification and regeneration consecutively), whereas an apparatus with more than one electrolytic cell units may be applied batch wise or continuous, with the latter option having the advantages of a continuous process. Hence, in an embodiment the decalcifying apparatus is configured to operate the first operation condition and the second operation condition spatially separated from each other, i.e. e.g. in different electrolytic cell units and in yet another embodiment the decalcifying apparatus is configured to operate the first operation condition and the second operation condition temporarily separated from each other, i.e. e.g. in the same electrolytic cell unit, but at another time (i.e. a purification stage followed by a regeneration stage). The term “operation condition” may also refer to “operation stage” or “operation mode”, etc.

Herein, the term “electrolytic cell unit” refers to a unit comprising the first electrode arrangement and the second electrode arrangement. Especially, these are separated by a treatment space. Further, between the first electrode arrangement and the second electrode arrangement, optionally the ion generating body may be arranged. The ion generating body may thus be configured to split the electrolytic cell unit (or electrolytic cell section) into two (separate) cells. By using a flow of the aqueous solution through the electrolytic cell unit or by using an isolating arrangement (in combination with the ion generating body)(see also below), the two cell parts (of the electrolytic cell unit) may substantially be isolated from each other (though downstream they aqueos liquid from both parts may be combined again). Note that when an water-splitting membrane may be used, the water-splitting membrane may provide a third volume, between the respective two cell parts.

The apparatus as described herein may include a plurality of electrolytic cells, which may in an embodiment be configured in series, in an embodiment be configured parallel, and in yet a further (hybrid) embodiment some of them may be configured in series and some of them may be configured parallel.

The ion generating body may (when interposed) be configured to substantially block recombination between ions desorbed from the respective (facing) first and second electrosorption electrodes and may be configured to generate hydrogen and hydroxide ions, especially thereby maintaining charge balance with these desorbed ions. Hence, the term “interposed” especially indicates that the ion generating membrane is configured between the first electrode arrangement, more especially the first electrosorption electrode, and second electrode arrangement, more especially the second electrosorption electrode. Due to the interposed electrode, a direct (linear) migration from ions from one electrode to the other may not be possible.

Note that the first electrosorption electrode and the second electrosorption electrode may especially be arranged parallel to each other. Further these electrodes may in general have a similar height or length. Likewise, the ion generating body may substantially have the same height or length, allowing a layered structure of first electrosorption electrode, space for aqueous solution, ion generating body, space for aqueous solution, second electrosorption electrode. Hence, the ion generating body may be configured to at least partially fluidically isolate the aqueous liquid at the first electrosorption electrode side of the electrolytic cell and the aqueous liquid at the second electrosorption electrode side of the electrolytic cell. Therefore, the ion generating body may especially be configured to at least partially fluidically isolate the first electrode arrangement from the second electrode arrangement.

The apparatus may further include a switching arrangement configured to transport one or more of the electrolytic cell and the ion generating body, to provide the first operation condition or the second operation condition.

The ion generating body may be a water-splitting membrane. Especially, the water-splitting membrane may be configured interposed (between the electrosorption electrodes, but not in physical and electrical contact with any of them).

The water-splitting membrane generates hydrogen cations and hydroxide anions by auto-ionisation of water and therefore this arrangement prevents the formation of gas during the second operating condition, for example the formation of chlorine gas and hydrogen and oxygen gas which may be formed during electrolysis of water.

The water-splitting membrane may comprise an anion exchange membrane and a cation exchange membrane.

With this arrangement, in the second operating condition, the anion exchange membrane allows hydroxide ions to pass through it towards the first electrode arrangement and the cation exchange membrane allows hydrogen ions to pass through it towards the second electrode arrangement. Therefore, the efficiency of the electrolytic cell section is maximised.

The water-splitting membrane may comprise an exchange membrane flow spacer between the anion exchange membrane and the cation exchange membrane.

With this arrangement the flow spacer element provides space between the exchange membranes for untreated aqueous solution containing ions. This can contribute to the conductivity, and so lower the voltage drop over the water-splitting membrane. In such instance, there may be three volumes (and/or flows) of aqueous solution.

The water-splitting membrane may further comprise a proton conducting material between the anion exchange membrane and the cation exchange membrane.

With this arrangement the proton conducting material between the exchange membranes may facilitate the transport of hydrogen ions between the membranes, lowering the voltage drop over the water-splitting membrane.

The proton conducting material may be Nafion.

The decalcifying apparatus may comprise an isolating arrangement which, in the second operating condition, is configured to fluidically isolate the electrolytic cell section from a treated aqueous solution section for receiving treated aqueous solution.

An advantage of this arrangement is that it is possible to prevent resulting waste aqueous solution from contaminating treated water.

The isolating arrangement may be configured to fluidically isolate the first electrode arrangement (from the second electrode arrangement) (in the second operating condition).

Therefore, it is possible to prevent the recombination between regenerated ions from first and second electrode arrangements in the second operating condition.

The isolating arrangement may be on the ion generating body. This isolating arrangement could be a slidable seal that acts as a fluidic barrier when the ion generating body is in the interposed position between the electrode arrangements. Further, this isolating arrangement may also be used for other purposes. As also indicated below, the isolating arrangement may comprise a pump, a (check) valve, a barrier material which can be moved to block a fluid passageway, or any alternative device that may be configured to prevent fluid communication between fluid passageways and/or vessels.

The ion generating body may be an interposed electrode. Hence, especially, the electrode, as embodiment of the ion generating body, may be configured interposed (between the electrosorption electrodes, but not in physical and electrical contact with any of them).

Therefore, the ion generated body may be easily and cost-effectively produced.

The interposed electrode may be formed from carbon and/or titanium.

The surface area of the interposed electrode may be less than the surface area of each of the first electrode arrangement and second electrode arrangement.

This arrangement helps to ensure that the electrolysis reactions occur on the interposed electrode and not on the first electrode arrangement and second electrode arrangement.

The ion generating body may be configured to be absent from the electrolytic cell section in the first operating condition.

Alternatively, the ion generating body may be interposed in the electrolytic cell section in the first operating condition. Hence, in embodiments the ion generating body is configured to be absent from the electrolytic cell section in the first operating condition, or the ion generating body is interposed in the electrolytic cell section in the first operating condition.

In a specific embodiment, a decalcifying apparatus according to one aspect of the present invention is characterised in that the ion generating body is interposed in the electrolytic cell section (or electrolytic cell unit) only in the second operating condition. In yet another embodiment, a decalcifying apparatus according to one aspect of the present invention is characterised in that the ion generating body is interposed always in the electrolytic cell section (or electrolytic cell unit).

This arrangement helps to simplify the configuration of the decalcifying apparatus. Therefore, manufacture may be simplified and the reliability of the apparatus may be maximised.

The decalcifying apparatus may be configured, in the first operating condition, to apply a voltage between the first electrode arrangement, having a low potential, and the second electrode arrangement, having a high potential, to attract the ions to the electrode arrangements and remove the ions from the aqueous solution, and may be configured, in the second operating condition, to reverse the polarity to apply a voltage between the first and second electrode arrangements with the potentials reversed such that the first electrode arrangement has a high potential and the second electrode arrangement has a low potential to regenerate the ions removed from the aqueous solution.

The ion generating body may not be electrically connected. Therefore, the apparatus is simplified. Hence, the ion generating body may be a floating electrode. As indicated above, the ion generating body may be configured to divide the electrolytic cell unit in two parts, which (division) may especially be useful during regeneration. As the ion generation body does not need to be electrically connected, the construction—and thus production—of the apparatus may be greatly simplified. It surprisingly appears that with such floating electrode, efficient regeneration may be executed. Without externally providing a current to the ion generating body, ions are generated, as the floating electrode is configured in between (at least part) of the first electrode arrangement and second electrode arrangement. The floating electrode may (substantially) ensure that equal amounts of hydrogen cations and hydroxide anions are created, thereby (substantially) ensuring that the overall pH of the combined solutions in the electrolytic cell remains unaffected.

In yet a further embodiment, the decalcifying apparatus as defined herein may comprise an electrolytic cell unit comprising the first electrode arrangement and the second electrode arrangement, further optionally comprising an inlet for receiving said aqueous solution and an outlet for releasing said aqueous solution, wherein the electrolytic cell unit is especially configured as flow-through unit. When a separate inlet and outlet are applied, the apparatus may be configured to flow the aqueous solution between the first electrode arrangement, more especially the first electrosorption electrode, and the second electrode arrangement, more especially the second electrosorption electrode. Especially, the electrode arrangements may be configured parallel to each other. Yet more especially, the electrosorption electrodes are configured parallel to each other. In this way, the aqueous solution may flow between the electrode arrangements or electrosorption electrodes, respectively, entering the electrolytic cell unit at the opening and leaving at the outlet (depleted in ions (purified) or enriched in ions (regeneration mode)).

According to another aspect of the present invention, there is provided a domestic appliance comprising a decalcifying apparatus as defined in the claims.

According to another aspect of the present invention, there is provided a method of decalcifying an aqueous solution having a first operating condition for removing ions from aqueous solution and a second operating condition for regenerating the ions into aqueous solution, the first operating condition comprising (a) introducing an aqueous solution, and, (b) applying a voltage between a first electrode arrangement, having a low potential, and a second electrode arrangement, having a high potential, in the aqueous solution to attract the ions to the electrode arrangements and remove the ions from the aqueous solution; the second operating condition in which an ion generating body is interposed between each of the first and second electrode arrangements to define a first cell and a second cell, each cell containing an oppositely charged first and second electrode arrangement, the second operating condition comprising: (c) applying a voltage between the first and second electrode arrangements with the potentials reversed such that the first electrode arrangement has a high potential and the second electrode arrangement has a low potential to regenerate the ions removed from the aqueous solution in the first operating condition, and (d) removing the resulting waste aqueous solution from the electrolytic cell section. Especially, as indicated above, the ion generating body is not electrically connected. Further, as also indicated above, especially the first electrode arrangement comprises a first electrosorption electrode and wherein the second electrode arrangement comprises a second electrosorption electrode.

This provides for maximising the efficiency of the method of decalcifying an aqueous solution.

In the second operating condition the method may further comprise isolating the first and second electrode arrangements in an electrolytic cell section from the chamber.

An advantage of this method is that it is possible to easily prevent the regenerated ions from being passed into treated aqueous solution in the chamber.

In a further embodiment, a decalcifying apparatus may be applied, especially as defined herein, comprising an electrolytic cell unit comprising said first electrosorption electrode and said second electrosorption electrode, and wherein the first operating condition and second operating condition are alternated, and are executed in the same electrolytic cell unit. Further, in an embodiment the ion generating body is only interposed between each of the first and second electrode arrangements during the second operation condition. Alternatively, the ion generating body is interposed between each of the first and second electrode arrangements during both the first operation condition and the second operation condition. However, in yet a further embodiment the decalcifying apparatus is applied, especially as defined herein, such decalcifying apparatus especially including two electrolytic cells, a first electrolytic cell configured for the first operation condition and a second electrolytic cell configured for the second operation condition, and wherein the first operation condition and second operation condition are applied at the same time but in different electrolytic cell units.

These and other aspects of the invention will be apparent from and elucidated with reference to the embodiments described hereinafter.

Hence, in an embodiment the invention provides amongst others two types of electrodes used in two consecutive stages of electrical driving or in two parallel stages.

In an embodiment, in a first stage (herein also indicated as “purification stage” or “purification mode” or the “filling mode”), under normal (filling) operation, potentials are applied to first and second opposing “electrosorption” electrodes, to store cations in a first (low potential), and anions in a second electrode (high potential). This may ensure that the total ion content of the water passing the two electrodes will be significantly reduced, until the total absorption capacity of first and second electrosorption electrodes is reached. In a second stage (herein also indicated as “regeneration mode” or the “descaling mode”), for descaling maintenance, a third non-electrosorption electrode (with typically only geometric surface area) is interposed between first and second electrodes, such that (effectively) two separate cells are formed. The applied potentials are reversed (when the same cell is used as used for the purification stage), with a high potential to the first electrode, a low potential to second electrode and floating potential to the third electrode. Under influence of those potentials, the previously stored cations and anions will be effectively released to their respective cells, and each balanced by OH⁻ and H⁺ respectively, that forms by electrolysis reactions occurring at the third non-electrosorption electrode. Consequently, the first cell with the first electrode will become alkaline, converting the released calcium and magnesium ions into solid hydroxide salts. The second cell with the second electrode will become acidic, converting the released bicarbonate ions into CO₂ gas, and additionally the released chloride ions at the third electrode will react to chlorine gas. In addition the electrolysis reactions at the third electrode will form hydrogen gas in the first cell and oxygen gas in the second cell.

Would however the regenerating electrosorption cell not have an interposed ion generating body, as described in the present invention, this would imply a inefficient operation. To avoid calcification problems inside the regeneration cell a minimal flow rate has to be maintained, leading to a significant waste volume. Hence, the present invention with the ion generating body or interposed electrode provides large advantages over state of the art solutions, and reduces waste formation.

Hence, in embodiments a main element of the invention is an ion generating body present in the regeneration cell of a flow electrode electrosorption system. This ion generating body prevents the recombination of desorbed positive ions (particularly Ca²⁺) with desorbed negative ions (particularly HCO₃⁻), and thereby prevents calcification problems inside the regeneration cell, allowing for a more compact waste stream.

Since a flow electrode electrosorption system has two separate electrosorption cells, the ion generating body need only be placed in the regeneration cell and will not affect the purification cell. This allows for separate optimisation of both cells, with potential for optimal performance and minimal waste.

As indicated above, an ion generating body is applied. This ion generating body may comprise a water splitting membrane or simply an electrode (like a Pt plate). The latter is herein also indicated as third electrode. Advantages of this third electrode are:

Effective desorption. Since the dominant species of ions released from the first and second electrosorption electrodes are converted to other species, these desorbed ions do not prohibit the further release of remaining ions.

Cation/Anion exchange membranes in the electrode arrangements in physical contact with the electrosorption electrodes are not required. This is beneficial from cost perspective, but also electrode lifetime can be enhanced by inverting the polarities of first and second electrodes in subsequent filling-descaling cycles. Without the third electrode, polarity reversal in the descaling mode, would result in ions releasing from the first electrode being immediately re-absorbed in the second (opposed) electrode, and vice versa. So without a third electrode in between, cation/anion exchange membranes would be required to prevent this opposite re-absorption. Note however that the invention does not exclude cation/anion exchange membranes.

The interposed electrode introduces a large asymmetry in surface area, thereby preventing electrolysis at the electrosorption electrode, even at higher voltages and currents. This allows faster regeneration of the electrosorption electrode.

Electrolysis reactions create visible recognizable waste. Notably the calcium and magnesium ions in the alkaline cell will form solid calcium/magnesium hydroxide precipitation, that turn the water into a milky fluid. This can be easily recognized by the consumer as a waste, giving credibility to the descaling process.

The present invention allows that the total pH of combined solution volumes at both sides of the interposed ion generating body, such as an electrode, does not become acidic, avoiding potential damage to metal parts in the reservoir and further downstream inside the appliance.

An advantage of a (interposed) water splitting membrane, especially when ion exchange membranes are applies with a space(r) in between, may be that in addition to the above advantages for the (interposed) electrode), gas formation may be reduced or prevented.

In an embodiment, the electrosorption electrodes have a high (internal) surface area to store ions. Preferably these electrodes are made from activated carbon, as conventionally and cost-effectively applied in supercapacitors or capacitive deionisation applications. Surface areas of at least 500 m²/gr, such as at least 1000 m²/gr, are feasible.

In an embodiment, the third interposed electrode has a much smaller (internal) area than the electrosorption electrodes (such as at least 100 times smaller). This may ensure that the electrolysis reactions may only occur on this third electrode (and not at the first and second electrodes). Especially, the electrolysis electrode is made from carbon, for instance injection molded carbon, as conventionally and cost-effectively applied in fuel cells, or glassy carbon, or alternatively from titanium coated with a ruthenium or iridium oxide coating for prolonged lifetime (known in the art as dimensionally-stable-anode DSA).

We have surprisingly found that the third interposed electrode during regeneration does not require an electrical connection. If this third electrode remains unconnected, floating, it will automatically receive a potential in between opposing electrosorption electrodes. An advantage of a floating electrode is that it requires fewer components and allows for more design options. A further advantage of the floating electrode is that equal amounts of hydrogen cations and hydroxide anions are created at opposite sides of this electrodes, thereby ensuring that the overall pH of the combined solutions in the electrolytic cell remains unaffected. An alternative embodiment to the interposed electrode is an interposed bipolar membrane. Similar to the interposed electrode, this bipolar membrane may be inserted only during regeneration (though other embodiments are also possible, such as a permanent interposure, etc.). Also this interposed bipolar membrane does not need an electrical connection. A bipolar membrane may consist of a cation exchange membrane and anion membrane laminated together. During regeneration, especially the cation exchange membrane side should face the negative electrosorption electrode and releases H+ ions. Vice versa the anion exchange membrane side should face the positive electrosorption electrode and releases OH− ions. An additional advantage compared to a metal interposed electrode is that a bipolar membrane generates H+/OH− by auto-ionisation of water, not electrolysis, so hydrogen, oxygen and chlorine gas formation is avoided.

Assuming a switchable (such as a batch) system, the switch between electrode configurations in filling and descaling modes can occur in multiple ways, such as e.g. (a) by leaving the first and second electrodes in position and interposing a third electrode (for instance by rotation, see also elsewhere), (b) by translating first and second electrodes to a new position inside the appliance where the third electrode can be interposed, (c) by removing the first and second electrodes (preferably in a cartridge) from the appliance and inserting them into a different position or separate “descaling” device where the third electrode can be interposed. Advantage of this last approach is that after intensive use spare electrosorption electrodes could be purchased and replaced by the user.

Especially, in the descaling configuration with third electrode the two cells preferably are not in fluidic contact, such that recombination of acid and base is minimized. For instance, this could be achieved by a (temporary) sealing layer below the electrode. In addition this sealing layer prevents leakage of the waste fluid to the reservoir and possible further downstream electrolytic cells In an alternative embodiment the sealing function could be performed by check valves. In that embodiment both half cells have separate fluidic outlets, at least one of these contain a check valve before they are united further downstream into a single outlet. In normal purification operation the check valves will be open, but in zero-flow regeneration mode the check valves will prevent mixing between the fluids of both half cells, and prevent leakage to the reservoir and possible further electrolytic cells located downstream.

In embodiments, the first and second electrodes can be positioned at the entrance of a water reservoir, but also inside a reservoir. Advantage of the latter is that the capturing of ions is less time critical, for instance in a steam iron the filling operation is expected to take 20 seconds, while the residence time of the water in the reservoir is typically 30 minutes.

An alternative way of employing electrosorption has been described in US2013/0209916, which is incorporated herein by reference. Herein, an embodiment of a porous electrode is described, comprising a slurry phase of active carbon which can be flown in and out of the electrosorption cell.

Such system, referred to as “flow electrode electrosorption” allows in an embodiment of the present invention for a continuous process consisting of:

inside the purification electrosorption cell: adsorption of ions from input water onto the active carbon inside the slurry;

transport of slurry containing the adsorbed ions from the purification electrosorption cell to the regeneration electrosorption cell

inside the regeneration electrosorption cell: desorption of the ions from the slurry to the waste water stream

transport of the regenerated slurry from the regeneration electrosorption cell to the purification electrosorption cell

Compared to the conventional batch process, also described herein, this has the advantage that it may be easier to optimize, and it may have potential for superior and more robust purification and minimal waste performance.

Hence, the invention provides in a further embodiment a decalcifying apparatus as defined herein, the apparatus comprising a first electrolytic cell unit and a second electrolytic cell unit; wherein the first electrolytic cell unit comprises: a first electrolytic cell section configured to receive at least part of an aqueous solution; the first electrolytic cell section comprising a first electrode arrangement and a second electrode arrangement, wherein the first electrode arrangement comprises a first electrosorption electrode and wherein the second electrode arrangement comprises a second electrosorption electrode; wherein the second electrolytic cell unit comprises: a second electrolytic cell section configured to receive at least part of an aqueous solution; the second electrolytic cell section comprising a first electrode arrangement and a second electrode arrangement, wherein the first electrode arrangement comprises a first electrosorption electrode and wherein the second electrode arrangement comprises a second electrosorption electrode; and the decalcifying apparatus being configured to operate with the first electrolytic cell unit in a first operating condition for removing ions from aqueous solution; the decalcifying apparatus being configured to operate with the second electrolytic cell unit in a second operating condition for regenerating the ions into aqueous solution, wherein the ion generating body is interposed in the second electrolytic cell section in the second operating condition; wherein the first electrode arrangements and the second electrode arrangements comprise flowable electrosorption material in operation separated from the aqueous solution by membranes; wherein the decalcifying apparatus further comprises a flowable elctrosorption material circulation system configured to circulate the flowable electrosorption material between the electrode arrangements of the first electrolytic cell unit and the second electrolytic cell unit.

Hence, with such apparatus a continuous purification process may be provided.

As also described in US2013/0209916, the above described continuous flow-electrode system may include a flow anode containing a flowing anode active material and a flow cathode containing a flowing cathode active material. The anode active material and the cathode active material may include any one used in a typical continuous flow-electrode system, that is, a battery or storage battery, which may be appropriately selected by those skilled in the art in consideration of purposes and/or circumstances of using the same. In embodiments, the anode active material and the cathode active material may include different materials, or otherwise, the same material. An electrode material such as anode active material and/or the cathode active material may include porous carbon (activated carbon, carbon aerosol, carbon nanotube, etc.), graphite powder, metal oxide powder, and the like, which may be mixed with the electrolyte to be used in a fluidized state. This electrolyte may especially include a water-soluble electrolyte such as NaCl, H₂SO₄, HCl, NaOH, KOH, Na₂NO₃, etc. and an organic electrolyte such as propylene carbonate (PC), diethyl carbonate (DEC), tetrahydrofuran (THF), etc. In an embodiment, the anode includes an anode collector; an anode separation layer; an anode flow channel formed between the anode collector and the anode separation layer; and an anode active material flowing through the anode flow channel. In an embodiment, the cathode includes a cathode collector; a cathode separation layer; a cathode flow channel formed between the cathode collector and the cathode separation layer; and a cathode active material flowing through the cathode flow channel. Further, the electrode collector and the electrode separation layer may include any one used in conventional continuous flow-electrode systems (battery, storage battery, etc.), which may be appropriately selected or adopted by those skilled in the art in consideration of purposes and conditions of using the same.

The membranes, which are configured to keep the flowable electrosorption material in operation separated from the aqueous solution, may also be indicated as anode separation layer and cathode separation layer, respectively. The anode separation layer may be a microporous insulation separation membrane or anion-exchange (conductive) membrane, while the cathode separation layer may be a microporous insulation separation membrane or cation-exchange (conductive) membrane. The separation layer(s) is (are) used for electrical and physical separation, and the microporous insulation separation membrane allows ion transfer only while an ion-exchange (conductive) membrane may selectively transfer either cations or anions. The anode active material or the cathode active material may include a slurry phase active material including the anode active material or the cathode active material mixed with the electrolyte.

In an embodiment, the continuous flow-electrode system may include an anode including an anode collector, an anode separation layer, and an anode active material flowing through an anode flow channel formed between the anode collector and the anode separation layer; a cathode including a cathode collector, a cathode separation layer, and a cathode active material flowing through an anode flow channel formed between the cathode collector and the cathode separation layer. The aqueous solution is (or flows) between the anode and cathode. The continuous flow-electrode system may be a unit cell wherein two or more unit cells may be consecutively arranged, and may simultaneously and continuously flow an electrode material as well as the electrolyte. In an embodiment, the electrode material may be micro-capsulated to increase a contact area between the aqueous solution and the electrode material. More particularly, an anion separation layer (a dense layer selectively passing anions while blocking flow-through of a liquid electrolyte) and a cation separation layer (a dense layer selectively passing only cations) are used.

When using an electrode active material encapsulated by each selective ion layer, it may not be necessary to provide ion conductive dense layers between two electrodes. Alternatively, when a microporous insulation separation membrane allowing flow-through of the aqueous solution as well as ions is used, a contact area between the aqueous solution and encapsulated electrode active material particles is increased.

The micro-capsulated electrode may include in embodiments a core at the center and a shell surrounding the periphery of the core, wherein a shell material has the property of exchanging ions present in the electrolyte. According to one embodiment of the present invention, the shell material may include a polymer membrane containing a sulfonic acid group (SO₃⁻), carboxyl group (COO⁻) or phosphoric acid group (PO₄⁻), etc., which is capable of exchanging cations; or a polymer membrane containing a primary, secondary, tertiary or quaternary ammonium group bonded thereto, which is capable of exchanging anions. The micro-capsule may be prepared by a solid or liquid phase method. In particular, in the liquid phase method, a core/shell structure may be formed by, for example, an emulsion method using a surfactant, a polymerization method polymerizing monomers to prepare a shell material, or a method of injecting or extruding the core and shell, simultaneously or separately, in order to form a micro-capsulated electrode. Since the micro-capsulated electrode includes a single granule or individual granules agglomerated together and a shell surrounding the same, it has an advantage in that an electrode area per unit weight or volume is larger than that of a bulk electrode formed of all agglomerated granules.

### BRIEF DESCRIPTION OF THE DRAWINGS

Embodiments of the invention will now be described, by way of example only, with reference to the accompanying drawings, in which:

FIG. 1 shows a steam system iron with a decalcifying apparatus;

FIG. 2 shows a water jug with a decalcifying apparatus;

FIG. 3 is a schematic view of a decalcifying apparatus in a treatment mode;

FIG. 4 is a schematic view of the decalcifying apparatus shown in FIG. 3 in a regeneration mode;

FIG. 5 is a schematic view of another embodiment of a decalcifying apparatus in a treatment mode;

FIG. 6 is a schematic view of another embodiment of a decalcifying apparatus in a regeneration mode;

FIG. 7 is a schematic view of another embodiment of a decalcifying apparatus in a treatment mode;

FIG. 8 is a schematic view of another embodiment of a decalcifying apparatus in a regeneration mode;

FIG. 9 is a schematic view of another embodiment of a decalcifying apparatus in a treatment mode;

FIG. 10 is a schematic view of another embodiment of a decalcifying apparatus in a regeneration mode;

FIGS. 11a-11b, 12a-12b, 13, 14a-14b, 15a-15b, 16a-16b, 17a-17b, and 18 evaluate some alternative apparatus (11a-11b, 12a-12b, 13, 14a-14b, 15a-15b) as well as the apparatus as defined herein (16a-16b, 17a-17b; 18).

### DETAILED DESCRIPTION OF THE EMBODIMENTS

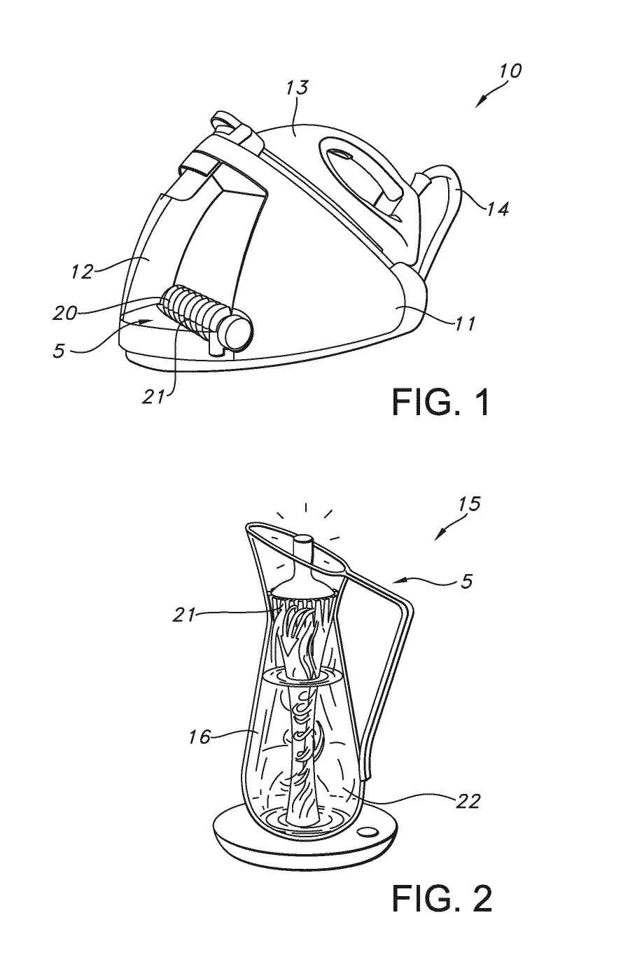

Referring to FIG. 1, there is shown a steam system iron 10. The steam system iron 10 comprises a base unit 11, an inlet reservoir 12 in the base unit 11, acting as a fluid reservoir, and a hand-held ironing unit 13. The inlet reservoir 12 is configured to hold an untreated aqueous solution, such as tap water, to be fed to a steam generator (not shown) in the base unit 11. The steam generator converts the fed aqueous solution to steam, which is fed to the ironing unit 13 through a hose 14. Alternatively, the steam generator (not shown) may be in the ironing unit 13. The ironing unit 13 is positionable against the fabric of a garment to emit steam onto the garment. Therefore, the fabric of a garment can be pressed and steamed.

The steam system iron 10 comprises a decalcifying apparatus 20. A detailed description of the decalcifying apparatus 20 will follow. The decalcifying apparatus 20 is disposed between the inlet reservoir 12 and the steam generator. The decalcifying apparatus 20 comprises an inlet communicating with the inlet reservoir 12, a treatment section 21 and a treated aqueous solution section (not shown). The treatment section 21 is between the inlet reservoir 12 and the treated aqueous solution section. Alternatively, the treatment section 21 is disposed in, adjacent to or spaced from the inlet reservoir 12. The treatment section 21 is in fluid communication with aqueous solution in the inlet reservoir 12. An untreated aqueous solution received in the inlet reservoir 12 is fed through the treatment section 21 where it is treated. The treated aqueous solution is then fed from the treatment section 21 to a treated aqueous solution section. In this embodiment, the treated aqueous solution section is a steam generator (not shown) or a fluid passageway leading to a steam generator. However, in an alternative embodiment, the treated aqueous solution section is a fluid outlet from the treatment section 21, including but not limited to, a fluid passageway such as a pipe, or a hose, or a fluid vessel such as a tank.

Although in FIG. 1 a steam system iron 10 is shown, the decalcifying apparatus 20 may be used with alternative garment care apparatus, as will become apparent hereinafter. For example, the decalcifying apparatus may be used with a steam iron or a garment steamer. An advantage of using a decalcifying apparatus 20 in a garment care apparatus, for example, is that the decalcifying apparatus 20 is able to act as a preventative measure to restrict calcification in the steam generator. This allows the steam generator to be designed without the need to account for calcification over time. Therefore, the size of steam generator may be minimised. Furthermore, scales will not be produced and will not be emitted towards garments being treated.

The decalcifying apparatus 20 is not limited to use with garment care apparatus. It is envisaged that the decalcifying apparatus 20 may be integrated into domestic appliances including, but not limited to, a floor steam cleaner, a food steamer, a kettle, a coffee maker, an espresso maker, a tea maker, a water carbonator, a water softener, a water purifier, an air humidifier, etc. The use of the decalcifying apparatus 20 in kettles and coffee makers may help to minimise maintenance and to prevent scales ending up in hot beverages. The treated aqueous solution can also be used in preparation of baby milk from powder to help reduce stress on the baby's kidneys, and to make soybean milk by aiding in the extraction of protein. In addition, it is envisaged that the decalcifying apparatus 20 may be used in conjunction with the kitchen sink water supply or for whole house water decalcifying applications.

The decalcifying apparatus is in general indicated with reference 5. For the sake of clarity, in some figures (and claims) the apparatus is numbered alternatively.

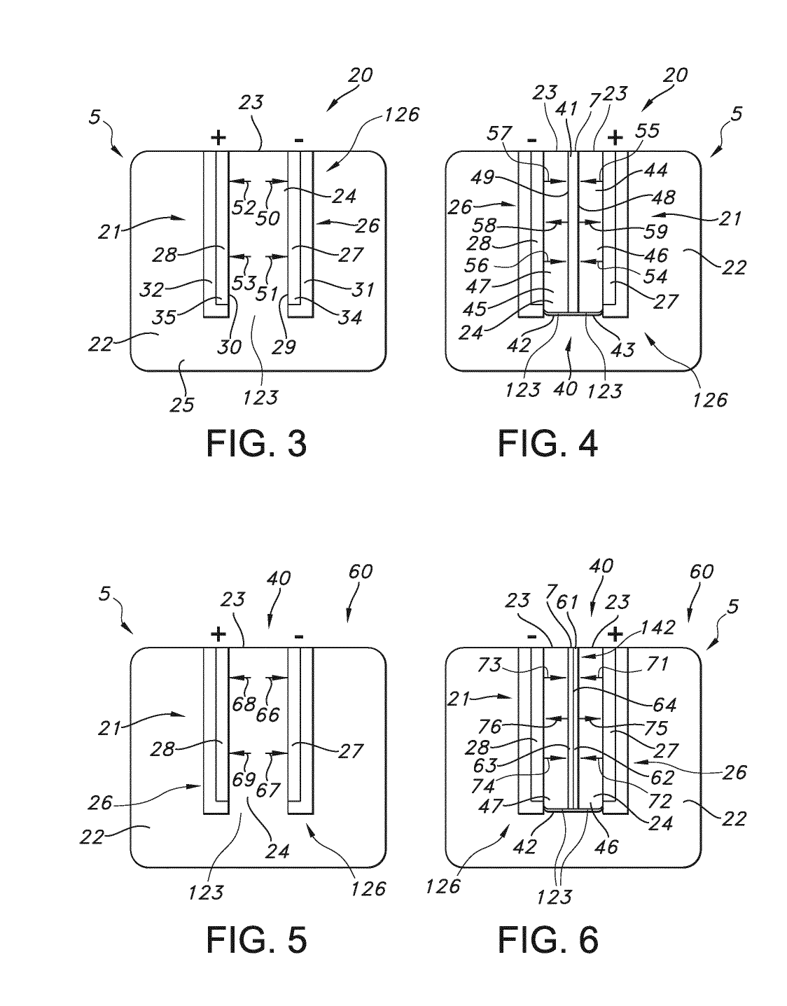

For example, referring to FIG. 2, there is shown a water jug 15 comprising a chamber 16 and a treatment section 21. The treatment section 21 is in the chamber 16 for an aqueous solution. In this embodiment, the chamber 16 acts as both the inlet reservoir and treated aqueous solution section. The untreated aqueous solution is fed into the treatment section 21 through a fluid passageway (not shown) where it is partially treated and expelled back into the chamber 16 through another fluid passageway (not shown). The partially treated aqueous solution is then fed back into treatment section 21 and continues to be recirculated until it is treated to the desired level.

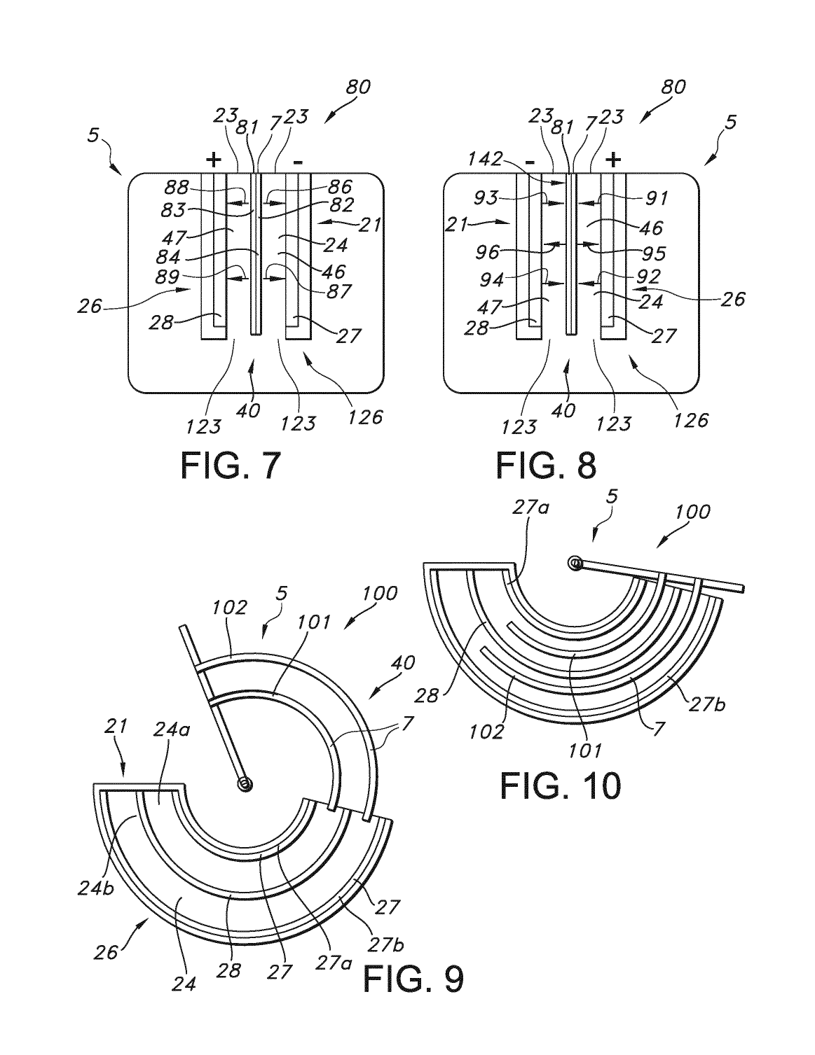

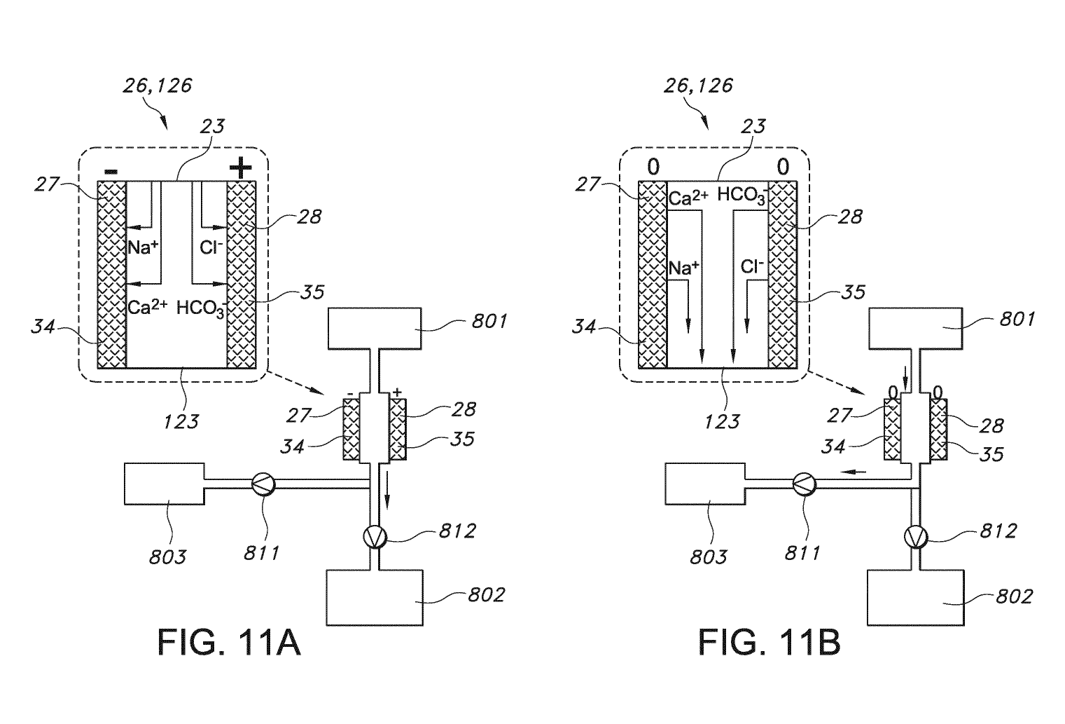

Referring now to FIGS. 3 and 4, there is shown a schematic view of one embodiment of the decalcifying apparatus 5, here indicated as decalcifying apparatus 20. The decalcifying apparatus 20 comprises the treatment section 21 and a chamber 22, acting as a treated aqueous solution section.

The decalcifying apparatus 20 is configured to operate in a treatment mode to remove substances from an aqueous solution to reduce the mineral content in the aqueous solution, for example to turn ‘hard’ water into ‘soft’ water. The decalcifying apparatus 20 is also configured to be operable in a regeneration mode to release the waste products from the treatment section 21 that have been removed from the aqueous solution during the treatment mode. ‘Hard’ water includes molecules such as sodium chloride (NaCl) and calcium carbonate (CaCO₃) dissolved in water (H₂O).

In FIG. 3, the decalcifying apparatus 20 is in a first operating condition. In the first operating condition the decalcifying apparatus 20 is in its treatment mode. That is, the decalcifying apparatus 20 is configured to remove substances such as, but not limited to, sodium, calcium, chloride, and bicarbonate ions from an aqueous solution received by the decalcifying apparatus 20. This apparatus may be used to remove heavy metal ions, for example, iron, cobalt, copper, manganese, molybdenum, zinc, mercury, plutonium and lead, from water.

In FIG. 4, the decalcifying apparatus 20 is in a second operating condition. In the second operating condition the decalcifying apparatus 20 is in its regeneration mode. That is, the decalcifying apparatus 20 is configured to regenerate the treatment section 21 by releasing the substances removed from the aqueous solution in the treatment mode.

The decalcifying apparatus 20 further comprises a fluid inlet 23 and a fluid outlet (123). The fluid inlet 23 may form the (or one of the) fluid outlet(s). In the present embodiment the fluid inlet 23 is defined by the treatment section 21. That is, a fluid path is formed through the treatment section 21. An aqueous solution therefore passes through the treatment section 21 to be received in the chamber 22. The fluid path defines a treatment space 24. The chamber 22 acts as the treated aqueous solution section, that is the downstream portion or fluid outlet of the treatment section 21. The treatment section 21 may especially be defined in embodiments as the space between the first electrosorption electrode 34 and the second electrosorption electrode 35. Further, the treatment section 21 may especially (also) be defined in embodiments as the space between the fluid inlet 23 and the fluid outlet 123. Hence, the electrolytic cell unit, indicated with reference 126, may also be defined in embodiments as the space between the first electrosorption electrode 34 and the second electrosorption electrode 35. Further, the electrolytic cell unit may especially (also) be defined in embodiments as the space between the fluid inlet 23 and the fluid outlet 123.

The treatment section 21 is disposed at the fluid inlet 23 of the chamber 22 so that aqueous solution fed into the fluid inlet 23 passes through the treatment section 21 to reach the chamber 22. Therefore, the fluid path is defined through the treatment section 21 from the fluid inlet 23. In such an embodiment an aqueous solution to be treated, for example ‘hard’ water, is treated by the treatment section 21 as it passes through the fluid path in the treatment section 21. With such an arrangement the treatment section 21 may have a flow restrictor (not shown) to limit the flow rate of the water through the fluid path. The flow restrictor acts to limit the flow rate to a rate such that the aqueous solution flowing through the treatment section is treated to a desired extent to remove the desired impurities from the aqueous solution. The flow restrictor may limit the area of a section of the flow path to limit flow rate, for example the fluid path may have a restricted diameter. Alternatively a restrictive element may be disposed in the fluid path. With such an arrangement the fluid path is configured to have a predetermined resistance to flow.

The treatment section 21 may be submerged in aqueous solution when aqueous solution is received in the chamber 22. This provides for the continued treatment of aqueous solution in the chamber 22 after it has flowed along the fluid path.

Alternatively, the treatment section 21 is disposed independently of the fluid inlet 23. In one such arrangement the treatment section 21 may be disposed proximate a fluid outlet independent of the fluid inlet 23. The treatment section 21 may be disposed at a lower end 25 of the chamber 22. In such an arrangement the chamber 22 acts as an untreated inlet reservoir. With such an arrangement an aqueous solution to be treated, for example ‘hard’ water, is treated by the treatment section 21 as it passes through the fluid path defining the treatment space 24 in the treatment section 21 from the chamber 22 to the fluid outlet. With such an arrangement the treatment section 21 may be submerged in aqueous solution when aqueous solution is received in the chamber 22. This provides for treatment of aqueous solution in the chamber 22 prior to the aqueous solution flowing out of the fluid outlet.

In one embodiment, the treatment section 21 is disposed to be submerged in aqueous solution when aqueous solution is received in the chamber 22. In one such arrangement the treatment section 21 may be spaced from the fluid inlet 23 and fluid outlet such that the treatment section 21 is located in the middle of the chamber 22. The treatment section 21 is in fluid communication with aqueous solution in the chamber 22. That is, the treatment section 21 is exposed to the aqueous solution. Therefore, aqueous solution in the chamber 22 may be treated in the treatment space 24. In the embodiment where the treatment section 21 is located in the middle of the chamber 22, the chamber 22 acts as both an inlet reservoir and the treated aqueous solution section. Partially treated aqueous solution which flows into the treatment space 24 passes out of the treatment section 21 and back into the chamber 22. The partially treated aqueous solution may follow this process until the desired level of treatment is reached. The treatment section 21 may be received in the chamber 22. The treatment section 21 may be spaced from the chamber 22 and connected via a passageway. The treatment section 21 may be disposed adjacent to the chamber 22.

In the above described embodiments the treatment section 21 is fixedly mounted in or relative to the chamber 22, acting as the treated aqueous solution section. Alternatively, the treatment section 21 may be removably mounted. Such an arrangement allows the treatment section 21 to be replaced or interchanged with an alternative treatment section 21. In one arrangement, the treatment section 21 is removable from fluid communication with the chamber 22 to be moved into its regeneration mode.

The treatment section 21 has an electrolytic cell section 26. The electrolytic cell section 26 comprises a first electrode arrangement 27 and a second electrode arrangement 28. The first and second electrode arrangements 27, 28 are connected to a power supply (not shown). The first and second electrode arrangements 27, 28 are submerged in aqueous solution received in the chamber 22. That is, the first and second electrode arrangements 27, 28 are in contact with aqueous solution. The first and second electrode arrangements 27, 28 are spaced from each other. The treatment space 24 is defined between the electrode arrangements 27, 28. The first electrode arrangement 27 has a first treatment surface 29 which faces the second electrode arrangement 28. The second electrode arrangement 28 has a second treatment surface 30 which faces the first electrode arrangement 27. A rear side of the first electrode arrangement 27 has a first electrode arrangement cover 31, although the cover 31 may be omitted. A rear side of the second electrode arrangement 28 has a second electrode arrangement cover 32, although the cover 32 may be omitted.

The first and second electrode arrangements 27, 28 are physically spaced from each other within the electrolytic cell section 26. For example, in one embodiment an electrode arrangement flow spacer (not shown) may be used. Aqueous solution is received in the treatment space 24 between the first electrode arrangement 27 and the second electrode arrangement 28. In the present embodiment, the first and second electrode arrangements 27, 28 are elongate. The first and second electrode arrangements 27, 28 have longitudinal axes extending in the chamber 22. The first and second electrode arrangements 27, 28 are (especially configured) parallel to each other.

The first electrode arrangement 27 is connected to one terminal of the power supply. In the treatment mode, as shown in FIG. 3, the first electrode arrangement 27 is provided with a negative electric charge (−). The second electrode arrangement 28 is connected to the other terminal of the power supply. In the treatment mode, as shown in FIG. 3, the second electrode arrangement 28 is provided with a positive electric charge (+). The aqueous solution provides the electrical connection between a submerged portion of the first electrode arrangement 27 and a submerged portion of the second electrode arrangement 28 to complete the electrical circuit.

The first and second electrode arrangements 27, 28 comprise electrosorption electrodes configured to adsorb substances onto their surface. The first electrode arrangement 27 comprises a first electrosorption electrode 34 and the second electrode arrangement 28 comprises a second electrosorption electrode 35. The first and second electrosorption electrodes 34, 35 are each configured to have a large surface area. The first and second electrosorption electrodes 34, 35 may have a porous structure. That is, the first and second electrosorption electrodes 34, 35 have a high internal surface area to allow the storage of ions. This provides a high internal surface area with a small external volume.

In the present arrangement, the first and second electrosorption electrodes 34, 35 are formed from activated carbon. However it will be understood that other suitable materials may be used. The activated carbon electrode may have a surface area of the order of 1000 m²/g.

Although in the present embodiment, as shown in FIG. 3, each of the first and second electrode arrangements 27, 28 have one electrosorption electrode, it will be understood that the invention is not limited thereto. In an alternative arrangement, the first electrode arrangement 27 may comprise more than one first electrosorption electrode 34. The second electrode arrangement 28 may comprise more than one second electrosorption electrode 35. In such an arrangement having two or more first electrosorption electrodes 34, and/or two or more second electrosorption electrodes 35, the first and second electrosorption electrodes 34, 35 may be alternately positioned within the electrolytic cell section 26. It will also be understood that the shape, size, and positioning of the electrodes may be configured to meet a specific set of requirements.

In one embodiment, the first and second electrode arrangements 27, 28 may each further comprise an ion exchange membrane layer thereon. In such an arrangement, the selectivity of the ion exchange membranes is selected such that it allows passage of the cations and anions to be absorbed by the corresponding electrosorption electrodes 34, 35. Therefore, the first electrode arrangement 27 may comprise a cation exchange membrane facing the second electrode arrangement 28. The second electrode arrangement 28 may comprise an anion exchange membrane facing the first electrode arrangement 27. One advantage of including ion exchange membranes inside the electrode arrangements is that it increases the ion adsorption capacity.

The decalcifying apparatus 20 further comprises a regeneration section 40. The regeneration section 40 is shown in FIG. 4. The regeneration section 40 comprises an ion generating body 41. The ion generating body 41 is receivable between the first and second electrode arrangements 27, 28. That is, the ion generating body 41 is receivable in the treatment space 24. The ion generating body is in general indicated with reference 7. Reference 41 herein especially refers to an interposed electrode as embodiment of the ion generating body 7.

The ion generating body 41 is configured to form hydrogen ions and hydroxide ions. The ion generating body 41 does not have a direct electrical connection. That is, the ion generating body 41 is not connected to the power supply.

In yet another aspect, the ion generating body 41 may be connected to the power supply (i.e. an electrode would not be floating).

In the present arrangement, the ion generating body 41 comprises an interposed electrolysis electrode. The interposed electrolysis electrode is configured to allow electrolysis reactions to occur on its surface. The surface area of the interposed electrolysis electrode is less than the surface area of each of the first and second electrosorption electrodes 34, 35. In the present embodiment, the interposed electrolysis electrode is formed from carbon, for instance injection moulded carbon or glassy carbon. However, it will be understood that the interposed electrolysis electrode may be formed from other suitable materials, for example titanium coated with a ruthenium or iridium oxide. Such an arrangement may prolong the lifetime of the interposed electrolysis electrode.

The regeneration section 40 further comprises an isolating arrangement 42. The isolating arrangement 42 is configured to isolate the treatment space 24. That is, the isolating arrangement 42 is configured to isolate the treatment space 24 from the, or the remainder of the, chamber 22 which is acting as the treated aqueous solution section. The isolating arrangement 42 may comprise a pump, a (check) valve, a barrier material which can be moved to block a fluid passageway, or any alternative device that prevents fluid communication between fluid passageways and/or vessels.

In the present embodiment the isolating arrangement 42 is a valve. The valve comprises a slidable seal 43, acting as a barrier. The seal 43 is disposed at a distal end of the ion generating body 41. The seal 43 is formed from a rubber plate, although it will be understood that alternative arrangements are envisaged. In some embodiments the isolating arrangement 42 may be omitted as will become apparent hereinafter. The isolating arrangement 42 may thus in embodiments (temporarily) close the fluid outlet 123. Hence, the electrolytic cell unit may be configured as flow-through until, but also as unit that can be operated batch wise.

Note that in embodiments the switching arrangement (not shown) or alternatively another arrangement (not shown) may be configured to control the isolating arrangement.

The regeneration section 40 is removably receivable in the treatment space 24. The regeneration section 40 is removed from the treatment space 24 during the first operating condition, that is the treatment mode, of the decalcifying apparatus 20. The regeneration section 40 is received in the treatment space 24 during the second operating condition, that is the regeneration mode, of the decalcifying apparatus 20. When the regeneration section 40 is received in the treatment space 24, the ion generating body 41 is interposed between the first electrode arrangement 27 and the second electrode arrangement 28. The ion generating body 41 separates the treatment section 21 into a first cell 44 and a second cell 45.

The first cell 44 is defined by the ion generating body 41 and the first electrode arrangement 27. The second cell 45 is defined by the ion generating body 41 and the second electrode arrangement 28. The ion generating body 41 divides the treatment space 24 of the treatment section 21 to define a first cell space 46 in which a portion of the aqueous solution is receivable and a second cell space 47 in which a portion of the aqueous solution is receivable. The ion generating body 41 acts to divide the treatment space 24 into the first cell space 46 and the second cell space 47. The ion generating body 41 separates the first and second electrode arrangements 27, 28. That is, the ion generating body 41 extends across the treatment space 24 and so acts to separate the first and second electrode arrangements 27, 28 from each other. As the isolating arrangement 42 is located at the distal end of the ion generating body 41, the isolating arrangement 42 is able to isolate the second cell space 47 from the first cell space 46 by preventing fluid communication between the two cell spaces 46, 47 and the remainder of the chamber 22.

The ion generating body 41 has a first surface 48 which forms part of the first cell 44, and a second surface 49 which forms part of the second cell 45. The first surface 48 faces the first electrode arrangement 27. The second surface 49 faces the second electrode arrangement 28.

The ion generating body 41 is spaced from the first and second electrode arrangements 27, 28. That is, the decalcifying apparatus 20 is configured so that the ion generating body 41 does not directly contact the first and second electrode arrangements 27, 28.

As described above, in the treatment mode of the decalcifying apparatus 20, the first electrode arrangement 27 is provided with a negative electric charge (−) and the second electrode arrangement 28 is provided with a positive electric charge (+).

In the regeneration mode of the decalcifying apparatus 20, the polarity of the first and second electrode arrangements 27, 28 is reversed. That is, the first electrode arrangement 27 is provided with a positive electric charge (+) and the second electrode arrangement 28 is provided with a negative electric charge (−). A controller (not shown) is operable to operate the power supply and to reverse the polarity of the first and second electrode arrangements 27, 28. The controller (not shown) may be a manual device.

A switching arrangement (not shown) is provided to change the decalcifying apparatus 20 between its treatment mode and its regeneration mode. The switching arrangement comprises the controller configured to change the polarity of the first and second electrode arrangements 27, 28. The switching arrangement enables the regeneration section 40 to move between its treatment mode, in which it is retracted from between the first and second electrode arrangements 27, 28, and its regeneration mode, in which it is received between the first and second electrode arrangements 27, 28.

The switching arrangement enables the ion generating body 41 to be introduced into the electrolytic cell section 26. The ion generating body 41 forms a barrier therein. The ion generating body 41 also defines the first cell 44 and the second cell 45 of the electrolytic cell section 26. It will be understood that the switching arrangement for switching between the treatment mode and the regeneration mode may be facilitated in a number of different ways.

For example, in the embodiment shown in FIGS. 3 and 4, the regeneration section 40 may be actuated to slide into the treatment space 24, with the ion generating body 41 being received between the first and second electrode arrangements 27, 28 and the seal 43 isolating the treatment space 24 from the remainder of the chamber 22, acting as the treated aqueous solution section. This may be a linear movement, or in an alternative arrangement a radial movement. In such an arrangement the regeneration section 40 may be a cartridge which is inserted into the chamber 22.

In an alternative arrangement, the treatment section 21 is moved within the chamber 22, acting as the treated aqueous solution section, to be received over the regeneration section 40. With such an arrangement, the treatment section 21 may be disposed in the chamber 22, or elsewhere. It will be also understood that the treatment section 21 and the regeneration section 40 may be moved into and out of communication with each other.

In an alternative arrangement, the treatment section 21 may be removed from the chamber 22, acting as the treated aqueous solution section. In such an arrangement the treatment section 21 may be formed as a cartridge which is removable from the chamber 22 and is inserted into a different position or a separate descaling device (not shown) where the regeneration section 40 is disposed.

During operation of the decalcifying apparatus 20, the decalcifying apparatus 20 is initially in its treatment mode, as shown in FIG. 3. The regeneration section 40 is not received in the treatment space 24. The treatment section 21 is in fluid communication with the chamber 22, which acts as the treated aqueous solution section.

The decalcifying apparatus 20 is operated so that a voltage is applied between the first electrode arrangement 27 and the second electrode arrangement 28.

An aqueous solution is introduced through the fluid inlet 23. The aqueous solution flows into the container through the fluid inlet 23 at the top end of the chamber 22. Aqueous solution may be introduced into the chamber 22 until it is full.

In the present arrangement the decalcifying apparatus 20 is operated in its treatment mode as an aqueous solution is fed into the chamber 22, acting as the treated aqueous solution section. However, it will be understood that alternatively, or as well as, the decalcifying apparatus 20 may be operated following the aqueous solution being fed into the decalcifying apparatus 20. One advantage of operating the decalcifying apparatus 20 during filling the chamber 22 is that the aqueous solution is treated as it enters the chamber 22. It will also be understood that in an arrangement in which the decalcifying apparatus 20 is operated in its treatment mode following introduction of the aqueous solution, it is possible to maximise the proportion of unwanted substances removed from the aqueous solution.

In the present arrangement, the aqueous solution introduced into the container by the user is ‘hard’ water. Such ‘hard’ water includes typically unwanted substances sodium, chloride, calcium and bicarbonate ions. During operation of the decalcifying apparatus 20, the applied voltage causes a potential difference between the first electrode arrangement 27 and the second electrode arrangement 28. Typically a potential difference of 1 to 5 volts is used in the treatment mode. Cations, Na⁺ (identified by arrow 50 in FIG. 3) and Ca²⁺ (identified by arrow 51 in FIG. 3), have a positive charge and so are attracted to the negatively charged, first electrode arrangement 27, acting as a cathode. Therefore, in treatment mode, the first electrode arrangement 27 acts as a cathode attracting sodium and calcium cations.

Anions, Cl⁻ (identified by arrow 52 in FIG. 3) and HCO₃⁻ (identified by arrow 53 in FIG. 3), have a negative charge and so are attracted to the positively charged second electrode arrangement 28, acting as an anode. Therefore, in the treatment mode, the second electrode arrangement 28 acts as an anode attracting chloride and bicarbonate anions.

Whilst the potential difference is applied between the first and second electrode arrangements 27, 28 the cations (Na⁺, Ca²⁺) formed in the aqueous solution are attracted to and received by the first electrode arrangement 27, and the anions (Cl⁻, HCO₃⁻) formed in the aqueous solution are attracted to and received by the second electrode arrangement 28. When the cations reach the cathode they are adsorbed from the aqueous solution onto the surface of the first electrode arrangement 27. When the anions reach the anode they are adsorbed from the aqueous solution onto the surface of the second electrode arrangement 28. Once a predetermined period of time has been reached, the power supply is disconnected and so the first and second electrode arrangements 27, 28 are deactivated. An electrode arrangement with an external volume of 0.016 litres (16 mL) is typically able to fully deionise one litre (1 L) of ‘hard’ (17 dH) water. Therefore, the level of unwanted substances, such as sodium chloride, NaCl, and calcium carbonate, CaCO₃ has been reduced to a desired level.

The cations (Na⁺, Ca²⁺) removed from the treated aqueous solution are retained on the first electrode arrangement 27. The anions (Cl⁻, HCO₃⁻) removed from the treated aqueous solution are retained on the second electrode arrangement 28. The aqueous solution in the chamber 22 is therefore treated and is now able to be used. Such treated water will be able to be used without the formation of scales.

The user switches the decalcifying apparatus 20 into its regeneration mode. The decalcifying apparatus 20 is actuated to interpose the regeneration section 40 in the treatment space 24. The decalcifying apparatus 20 is also actuated to reverse the polarity of the first and second electrode arrangements 27, 28.

When the regeneration section 40 is received in the treatment space 24, as shown in FIG. 4, the ion generating body 41 separates the treatment space 24 into the first cell space 46 and the second cell space 47. The isolating arrangement 42 isolates the treatment space 24 from the remainder of the chamber 22. The isolating arrangement 42 isolates the second cell space 47 and the first cell space 46 from each other. The user uses the switching arrangement to switch between the first configuration, that is the treatment mode, and the second configuration, that is the regeneration mode. As a result there is no fluid connection between the first cell 44 and the second cell 45, or the chamber 22.

When the decalcifying apparatus 20 is operated to reverse the polarity of the first and second electrode arrangements 27, 28, the first electrode arrangement 27 has a high potential or positive charge (+). The second electrode arrangement 28 has a low potential or negative charge (−). In the regenerating mode, the applied potential difference will generally be greater than the applied potential difference in the treatment mode, because of the presence of a voltage drop over the ion generating body 41. Typically potential differences between 1V and 40V are applied between the first and second electrode arrangements 27, 28. It will be understood that the first and second electrode arrangements 27, 28 are not provided with a reversed polarity until the regeneration section 40 is received in the treatment space 24. That is, the power supply is not operated to provide a reversed polarity to the first and second electrode arrangements 27, 28 until the isolating arrangement 42 is disposed to isolate the treatment space 24 from the remainder of the chamber 22. A quantity of treated or untreated aqueous solution is retained in the treatment space 24. Alternatively, a quantity of treated or untreated aqueous solution may be introduced into the treatment space 24. In the second configuration, regeneration mode, the first electrode arrangement 27 acts as a anode repelling the sodium and calcium cations, Na⁺ (identified by arrow 54 in FIG. 4) and Ca²⁺ (identified by arrow 55 in FIG. 4), from its surface 29. Therefore, the unwanted substances are expelled from the first electrode arrangement 27 into the small volume of aqueous solution in the treatment space 24.

In the second configuration, regeneration mode, the second electrode arrangement 28 acts as a cathode repelling the chloride and bicarbonate anions, Cl⁻ (identified by arrow 56 in FIG. 4) and HCO₃⁻ (identified by arrow 57 in FIG. 4), from its surface 30. Therefore, the unwanted substances are expelled from the second electrode arrangement 28 into the small volume of aqueous solution in the treatment space 24.

In the reversed electric field the anions (Cl⁻, HCO₃⁻) are attracted to the first electrode arrangement 27, acting as an anode. The interposed electrolysis electrode forming the ion generating body 41 prevents the anions (Cl⁻, HCO₃⁻), desorbed by the second electrode arrangement 28, from being readsorbed onto the first electrode arrangement 27. In the reversed electric field the cations (Na⁺, Ca²⁺) are attracted to the second electrode arrangement 28, acting as a cathode. The interposed electrolysis electrode forming the ion generating body 41 prevents the cations (Na⁺, Ca²⁺), desorbed by the first electrode arrangement 27, from being readsorbed onto the second electrode arrangement 28.

Furthermore, the ion generating body 41 acts to prevent the anions (Cl⁻, HCO₃⁻), desorbed by the second electrode arrangement 28 from recombining with the cations (Na⁺, Ca²⁺), desorbed by the first electrode arrangement 27, thereby preventing the formation of CaCO₃ calcification inside the treatment section 21.

The interposed electrolysis electrode forming the ion generating body 41 does not have an electrical connection; however it will be understood that the interposed electrolysis electrode has a potential in between that of the first and second electrode arrangements 27, 28. Therefore, the interposed electrolysis electrode is able to decompose the water (H₂O) received in the first and second cells 44, 45.

In the first cell 44, the interposed electrolysis electrode releases hydroxide anions OH⁻ (identified by arrow 59 in FIG. 4) and hydrogen gas (H₂). The hydroxide anions (OH⁻) react with the desorbed sodium and calcium cations (Na⁺, Ca²⁺) to form sodium hydroxide (NaOH) and calcium hydroxide (Ca(OH)₂). Therefore, the aqueous solution in the first cell 44 becomes an alkaline solution.

In the second cell 45, the interposed electrolysis electrode releases hydrogen cations, H⁺ (identified by arrow 58 in FIG. 4) and oxygen gas (O₂). The hydrogen cations (H⁺) react with the desorbed chloride and bicarbonate anions (Cl⁻, HCO₃⁻) to form hydrochloric acid (HCl) and carbonic acid (H₂CO₃).

The processes in the second cell 45 may also produce carbon dioxide gas (CO₂) and chlorine gas (Cl₂). The carbonic acid (H₂CO₃) decomposes into water (H₂O) and carbon dioxide (CO₂) to maintain the equilibrium between the molecules. Chlorine gas (Cl₂) is formed on the surface of the interposed electrolysis electrode when two chloride anions (Cl⁻) lose an electron to the interposed electrolysis electrode and combine. The aqueous solution in the second cell 45 becomes an acidic solution.

Advantageously, the reactions of the desorbed ions with hydroxide anions (OH⁻) in the first cell 44 and the hydrogen cations (H⁺) in the second cell 45 means that the desorbed ions are converted into other species and so do not prohibit the desorption of the remaining adsorbed ions on the surface of the electrode arrangements 27, 28.

FIGS. 3-4 schematically depict an embodiment of the apparatus which may be configured to operate the first operation condition and the second operation condition temporarily separated from each other.

As shown in FIG. 4, the ion generating body may be configured to at least partially fluidically isolate the aqueous liquid at the first electrosorption electrode side of the electrolytic cell and the aqueous liquid at the second electrosorption electrode side of the electrolytic cell. Therefore, the ion generating body may especially be configured to at least partially fluidically isolate the first electrode arrangement from the second electrode arrangement. Together with the isolating arrangement 42, isolation may be complete. The ion generating body 41 splits the electrolytic cell unit, indicated with reference 126. The electrolytic cell unit 126 is especially defined by a unit comprising the first electrode arrangement and the second electrode arrangement. Especially, these are separated by a treatment space.

The large asymmetry in surface area, caused by the interposed electrolysis electrode forming the ion generating body 41 having a surface area which is much less than the surface area of the first and second electrode arrangements 27, 28, means that electrolysis only takes place on the interposed electrolysis electrode. This prevents electrolysis taking place at the first and second electrode arrangements 27, 28, and so allows the operating current to be maximised. Advantageously, this allows faster regeneration of the first and second electrode arrangements 27, 28.

The interposed electrolysis electrode prevents the alkaline solution in the first cell 44 from interacting with the acidic solution in the second cell 45. Therefore, the ions adsorbed onto the first and second electrode arrangements 27, 28 are prevented from recombining.

In addition, by preventing recombination of the adsorbed ions, the interposed electrolysis electrode causes calcium hydroxide precipitation to form in the first cell 44. This acts to make the solution cloudy. Therefore, a visible indicator is provided to the user that the descaling process has been successful.

The isolating arrangement 42 prevents leakage of the waste aqueous solution generated during the regeneration mode into the treated aqueous solution in the remainder of the chamber 22, acting as the treated aqueous solution section. Therefore, the treated aqueous solution is not contaminated. The waste aqueous solution may be easily removed from the decalcifying apparatus 20. Furthermore, the volume of waste aqueous solution created is minimised. The waste aqueous solution may be emptied whilst the chamber 22 is still full of treated aqueous solution. In one embodiment, the decalcifying apparatus 20 may comprise a waste chamber (not shown) in which the alkaline solution and acidic solution are combined to neutralise the solutions before disposing of them.

The decalcifying apparatus 20 may then be returned to a neutral or treatment mode.

Although in the above described embodiment the hydrogen ion and hydroxide ion generating body 41 comprises one interposed electrolysis electrode, it will be understood that alternative arrangements are envisaged. For example, in an alternative arrangement three electrodes may be used with two ion generating bodies. In such an arrangement, the two outer electrodes may act as the first electrode arrangements and the inner electrode as the second electrode arrangement. The inner electrode would be able to function in two directions on either side of its body.

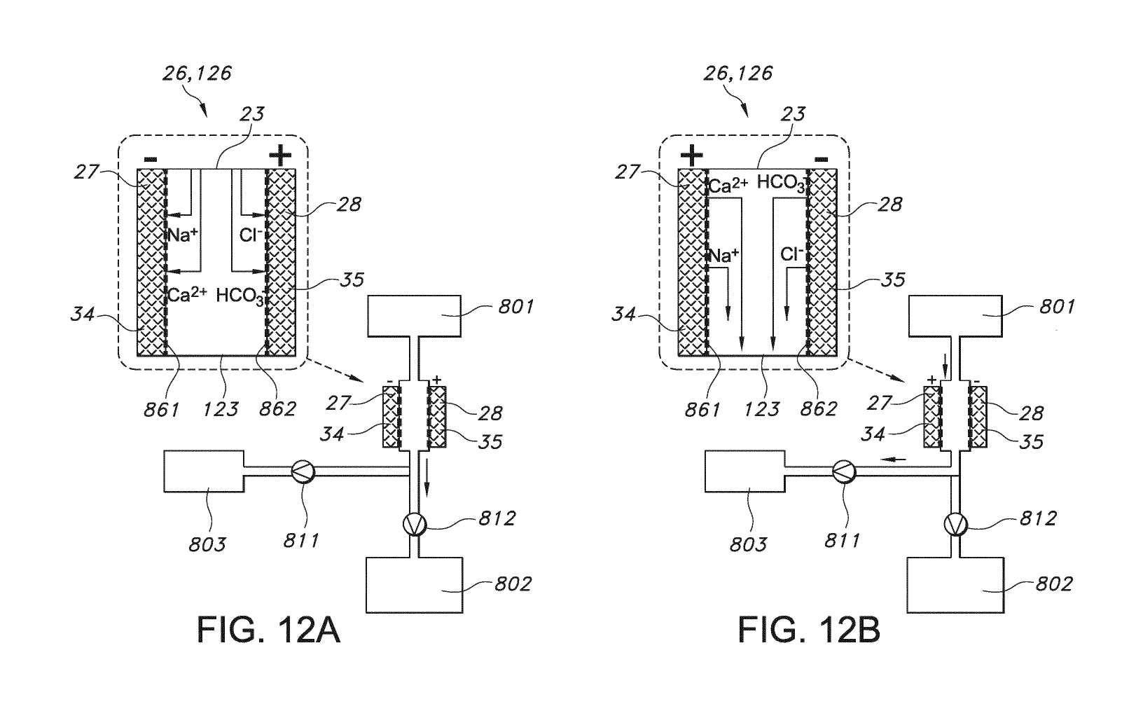

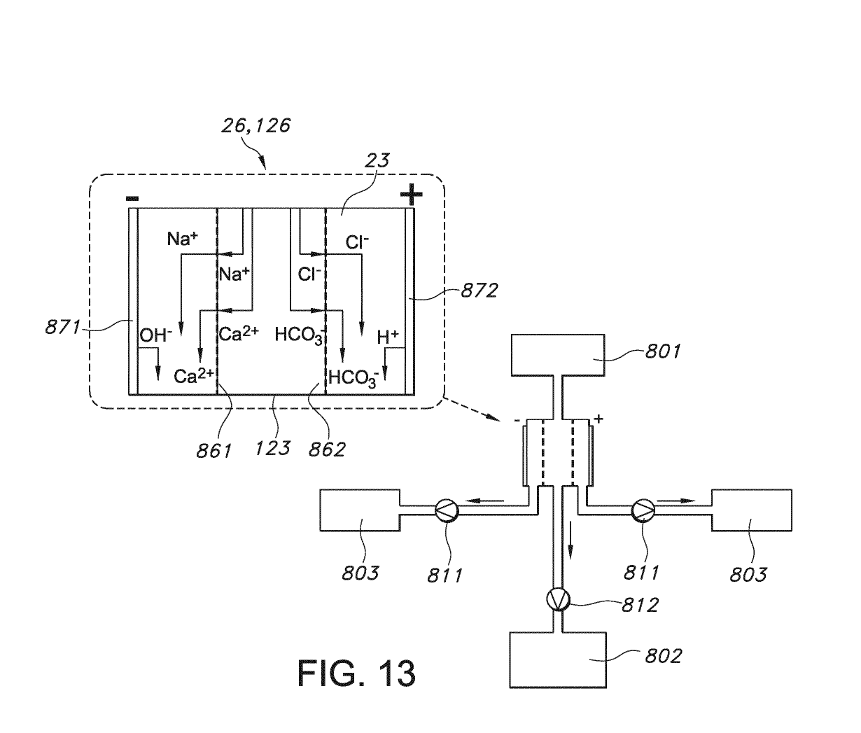

Although embodiments of the decalcifying apparatus are shown and described above with reference to FIGS. 3 and 4, it will be understood that alternative embodiments are envisaged. Referring now to FIGS. 5 and 6, an alternative embodiment of a decalcifying apparatus 60 is shown. The decalcifying apparatus 60 shown in FIGS. 5 and 6 is generally the same as the embodiments of the decalcifying apparatus 20 described above and so a detailed description will be omitted herein. Furthermore, features and components of the decalcifying apparatus 60 of the present embodiment corresponding to features and components of the decalcifying apparatus 20 described above will retain the same terminology and reference numerals. However, in the decalcifying apparatus 60 shown in FIGS. 5 and 6 a different type of ion generating body 61, comprising an interposed water-splitting membrane is used.

Referring to FIG. 5, the decalcifying apparatus 5, here indicated as decalcifying apparatus 60, is shown in its first operating condition. In the first operating condition the decalcifying apparatus 60 is in its treatment mode. That is, the decalcifying apparatus 60 is configured to remove substances such as, but not limited to, sodium, calcium, chloride, and bicarbonate ions from an aqueous solution received by the decalcifying apparatus 60. Referring to FIG. 6, the decalcifying apparatus 60 is in a second operating condition. In the second operating condition the decalcifying apparatus 60 is in its regeneration mode. That is, the decalcifying apparatus 60 is configured to regenerate the treatment section 21 by releasing the substances removed from the aqueous solution in the treatment mode.

In the present embodiment, the regeneration section 40 is shown in FIG. 6. The regeneration section 40 comprises the ion generating body 61. The ion generating body 61 comprises the interposed water-splitting membrane.

The interposed water-splitting membrane forming the ion generating body 61 is receivable between the first and second electrode arrangements 27, 28. That is, the ion generating body 61 is receivable in the treatment space 24. The interposed water-splitting membrane is configured to form hydrogen ions and hydroxide ions. Interposed water-splitting membrane does not have a direct electrical connection.

The regeneration section 40 further comprises an isolating arrangement 42. The isolating arrangement 42 is configured to isolate the treatment space 24. That is, the isolating arrangement 42 is configured to isolate the treatment space 24 from the, or the remainder of the, chamber 22, which acts as the treated aqueous solution section. When the regeneration section 40 is received in the treatment space 24, the water-splitting membrane is interposed between the first electrode arrangement 27 and the second electrode arrangement 28. The water-splitting membrane of the ion generating body 61 separates the treatment section 21 into a first cell space 46 and a second cell space 47.

A switching arrangement (not shown) is provided to change the decalcifying apparatus 60 between its treatment mode and its regeneration mode. The switching arrangement comprises the controller to change the polarity of the first and second electrode arrangements 27, 28. The switching arrangement also comprises a switching mechanism (not shown). In an embodiment, the switching arrangement (may be configured to) move(s) the regeneration section 40 between being received between the first and second electrode arrangements 27, 28 and being retracted from between the first and second electrode arrangements 27, 28. It will be understood that such a switching mechanism may cause a linear or rotational action, and may, for example, be activated by a knob, lever or motor. The switching mechanism may cause movement of the regeneration section 40 and/or the first and second electrode arrangements 27, 28.

The water-splitting membrane forming the ion generating body 61 comprises two layers laminated together. A first layer is formed by an anion exchange membrane 62. A second layer is formed by a cation exchange membrane 63. A junction 64 is defined between the anion exchange membrane 62 and the cation exchange membrane 63. Amongst others, references 61 and 81, etc., may refer to a water splitting membrane as embodiment of the ion generating body 7.

The anion exchange membrane 62 allows anions (negatively charged molecules) to cross the membrane 62 but substantially blocks cations (positively charged molecules). The anion exchange membrane 62 comprises positively charged surface groups, for example, quaternary ammonium, or any other suitable material. The cation exchange membrane 63 allows cations (positively charged molecules) to cross the membrane 63 but substantially blocks anions (negatively charged molecules). The cation exchange membrane 63 comprises negatively charged surface groups, for example, sulphonate, or any other suitable material.

The water-splitting membrane forming the ion generating body 61 is orientated so that the anion exchange membrane 62 faces the first electrode arrangement 27, and the cation exchange membrane 63 faces the second electrode arrangement 28. Orientation is such that, in the second operating condition, the regenerated ions from the first and second electrode arrangements 27, 28 are blocked by the facing ion exchange membranes 62, 63 of the water splitting membrane.

Operation of the embodiments of the decalcifying apparatus 60 described with reference to FIGS. 5 and 6 are generally the same as embodiments of the decalcifying apparatus 20 described with reference to FIGS. 3 and 4, and so a detailed description will be omitted herein.

When the decalcifying apparatus 60 is in the treatment mode, as shown in FIG. 5, the first electrode arrangement 27 is provided with a negative electric charge (−) and the second electrode arrangement 28 is provided with a positive electric charge (+). The regeneration section 40 is retracted from between the first and second electrode arrangements 27, 28.

When a potential difference is applied between the first and second electrode arrangements 27, 28, cations, Na⁺, Ca²⁺ (identified by arrows 66, 67 respectively) are attracted to the first electrode arrangement 27, acting as a cathode. Anions, Cl⁻, HCO₃⁻ (identified by arrows 68, 69 respectively) are attracted to the second electrode arrangement 28, acting as an anode. When the cations reach the first electrode arrangement 27 they are adsorbed from the aqueous solution onto the surface of the first electrode arrangement 27. When the anions reach the second electrode arrangement 28 they are adsorbed from the aqueous solution onto the surface of the second electrode arrangement 28.

Once the aqueous solution has been treated for a predetermined period of time, the levels of cations (Na⁺, Ca²⁺) and anions (Cl⁻, HCO₃⁻) are reduced to a desired level. The aqueous solution in the chamber 22 has then been treated. The sodium and calcium ions (Na⁺, Ca²⁺) are collected on the first electrode arrangement 27 and the chloride and bicarbonate ions (Cl⁻, HCO₃⁻) are collected on the second electrode arrangement 28.

The decalcifying apparatus 60 may then be operated in its regeneration mode. The decalcifying apparatus 60 is operable to switch into its regeneration mode. The decalcifying apparatus 60 is actuated to interpose the regeneration section 40 in the treatment space 24. The decalcifying apparatus 60 is also actuated to reverse the polarity of the first and second electrode arrangements 27, 28.

When the regeneration section 40 is received in the treatment space 24, as shown in FIG. 6, the ion generating body 61 (here especially the water-splitting membrane 142) divides the treatment space 24 into the first cell space 46 and the second cell space 47. The isolating arrangement 42 isolates the treatment space 24 from the remainder of the chamber 22, acting as the treated aqueous solution section. The isolating arrangement 42 isolates the first cell space 46 and the second cell space 47 from each other. The user uses the switching arrangement to switch between the first configuration, that is the treatment mode, and the second configuration, that is the regeneration mode.

When the decalcifying apparatus 60 is operated to reverse the polarity of the first and second electrode arrangements 27, 28 in the regeneration mode, the first electrode arrangement 27 has a high potential or positive charge (+). The second electrode arrangement 28 has a low potential or negative charge (−). It will be understood that the first and second electrode arrangements 27, 28 are not provided with a reversed polarity until the regeneration section 40 is received in the treatment space 24. That is, the power supply is not operated to provide a reversed polarity to the first and second electrode arrangements 27, 28 until the isolating arrangement 42 is disposed to isolate the treatment space 24 from the remainder of the chamber 22. A quantity of treated or untreated aqueous solution is retained in the treatment space 24. Alternatively, a quantity of treated or untreated aqueous solution may be introduced into the treatment space 24.

In the second configuration, regeneration mode, the first electrode arrangement 27 acts as a anode repelling the sodium and calcium cations, Na⁺ (identified by arrow 71 in FIG. 6) and Ca²⁺ (identified by arrow 72 in FIG. 6). Therefore, the unwanted substances are expelled from the first electrode arrangement 27 into the small volume of aqueous solution in the treatment space 24. The second electrode arrangement 28 acts as a cathode repelling the chloride and bicarbonate anions, Cl⁻ (identified by arrow 73 in FIG. 6) and HCO₃⁻ (identified by arrow 74 in FIG. 6). Therefore, the unwanted substances are expelled from the second electrode arrangement 28 into the small volume of aqueous solution in the treatment space 24. Reference 75 indicates released OH⁻ and reference 76 indicates released H⁺.

The water-splitting membrane of the ion generating body 61 is orientated so that the anion exchange membrane 62 faces the first electrode arrangement 27, and the cation exchange membrane 63 faces the second electrode arrangement 28. The anion exchange membrane 62 of the water-splitting membrane blocks cations (e.g. Na⁺, Ca²⁺) and so prevents them being reabsorbed by the second electrode arrangement 28, acting as a cathode. The cation exchange membrane 63 blocks anions (e.g. Cl⁻, HCO₃⁻) and so prevents them being reabsorbed by the first electrode arrangement 27, acting as an anode. Therefore, the anions (Cl⁻, HCO₃⁻) and the cations (Na⁺, Ca²⁺) are prevented from passing through the water-splitting membrane. The water-splitting membrane acts to prevent the recombination of desorbed Ca²⁺ cations and HCO₃⁻ anions, so preventing CaCO₃ calcification.

The water-splitting membrane of the ion generating body 61 splits the water molecules (H₂O) into hydrogen cations (H⁺) and hydroxide anions (OH⁻) by auto-ionisation. Water molecules are split at the junction 64 of the water-splitting membrane. The water (H₂O) at the junction 64 between the anion exchange and cation exchange membranes 62, 63 are partially dissociated into hydrogen (H⁺) and hydroxide (OH⁻) ions. Water molecules (H₂O) are transported to the junction 64 of the water-splitting membrane by diffusion.

The hydroxide anions (OH⁻) pass through the anion exchange membrane 62 under the influence of the electric field. The hydroxide anions (OH⁻) are attracted towards the first electrode arrangement 27, acting as an anode, into the first cell space 46. In the first cell space 46, the hydroxide anions (OH⁻) react with the cations (Na⁺, Ca²⁺) desorbed from the surface of the first electrode arrangement 27 to form a precipitate and alkaline solution.

The hydrogen cations (H⁺) pass through the cation exchange membrane 63 under the influence of the electric field. The hydrogen cations (H⁺) are attracted towards the second electrode arrangement 28, acting as a cathode, into the second cell space 47. In the second cell space 47, the hydrogen cations (H⁺) react with the anions (Cl⁻, HCO₃⁻) desorbed from the surface of the second electrode arrangement 28 to form an acidic solution. Use of a water-splitting membrane provides for water to be decomposed by auto-ionisation and not electrolysis and so the formation of chlorine gas (Cl₂) is prevented. The formation of hydrogen (H₂) and oxygen (O₂) gas produced by the electrolysis of water is also prevented.

In an alternative embodiment the water is allowed to flow through the treatment space 24 during the regeneration mode. Such an arrangement may include a separate flow path for water, independent of the chamber 22, acting as the treated aqueous solution section. An advantage of this arrangement is that regenerated ions are washed out of the electrolytic cell section, for example into a waste chamber (not shown). Furthermore, the water-splitting membrane is provided with a constant stream of water molecules (H₂O) that it can use to produce the hydrogen (H⁺) and hydroxide (OH⁻) ions. Furthermore, the products of the regeneration process may be washed out of the electrolytic cell section by the incoming waste water flow. The alkaline and acidic solutions may then recombine further downstream of the electrolytic cell section to produce a neutral solution containing the waste products which can then be safely disposed. A separate flow path may also be used together with the embodiments described above with reference to FIGS. 3 and 4, as well as the embodiments described hereinafter.

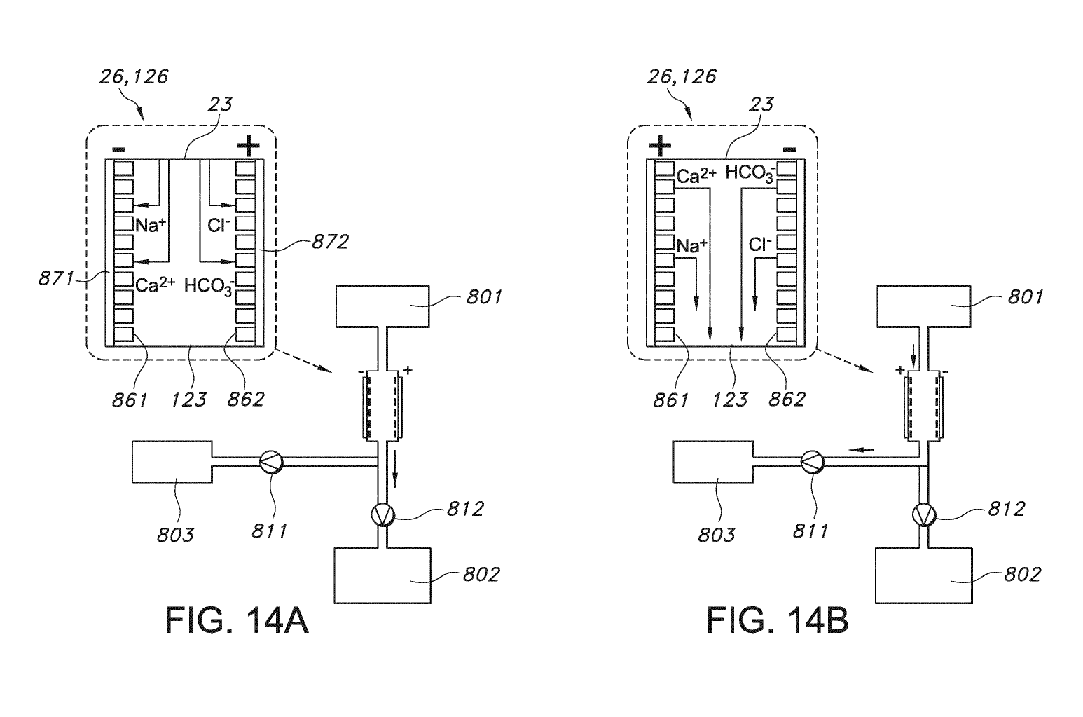

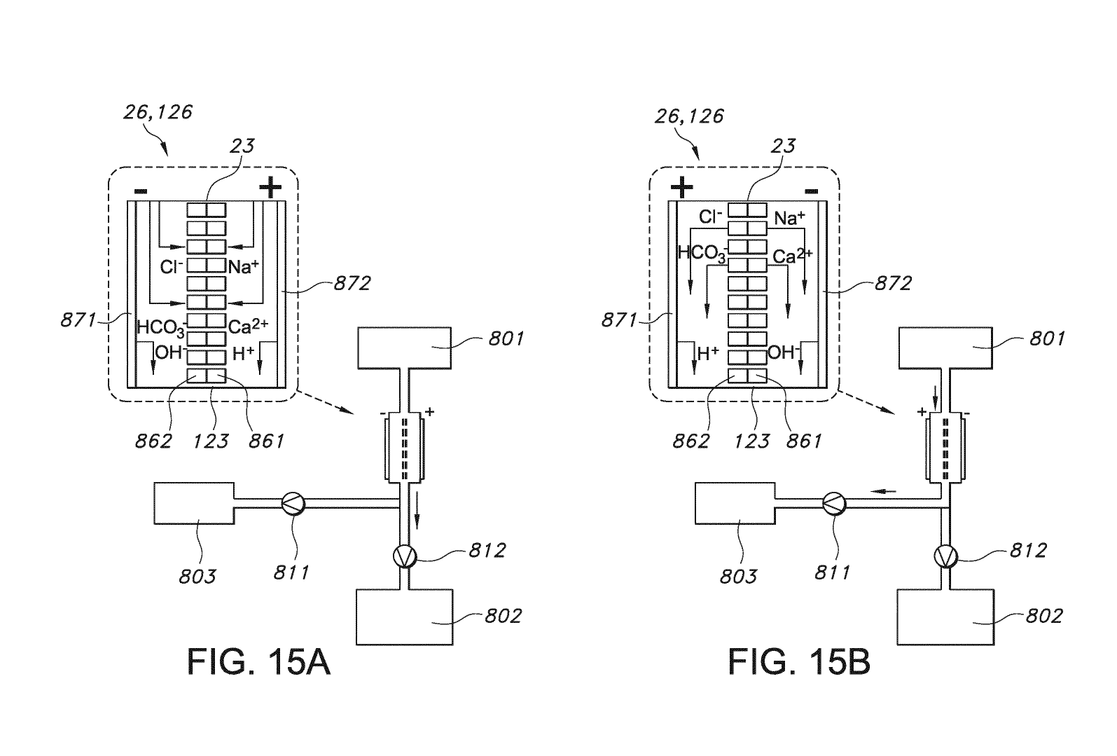

Referring now to FIGS. 7 and 8, an alternative embodiment of a decalcifying apparatus 80 is shown. The decalcifying apparatus 80 shown in FIGS. 7 and 8 is generally the same as the embodiments of the decalcifying apparatus 60 described above with reference to FIGS. 5 and 6 and so a detailed description will be omitted herein. Furthermore, features and components of the decalcifying apparatus 80 of the present embodiment corresponding to features and components of the decalcifying apparatus 60 described above will retain the same terminology and reference numerals. However, although in the above described embodiments the ion generating body is retracted from the treatment space 24 in the treatment mode, and is receivable in the treatment space 24 in the regeneration mode, in an alternative embodiment, an ion generating body 81 is fixedly mounted in the treatment space 24.

Referring to FIG. 7, the decalcifying apparatus 5, here indicated as decalcifying apparatus 80, is shown in its first operating condition. In the first operating condition the decalcifying apparatus 80 is in its treatment mode. That is, the decalcifying apparatus 80 is configured to remove substances such as, but not limited to, sodium, calcium, chloride, and bicarbonate ions from an aqueous solution received by the decalcifying apparatus 80. Referring to FIG. 8, the decalcifying apparatus 80 is in a second operating condition. In the second operating condition the decalcifying apparatus 80 is in its regeneration mode. That is, the decalcifying apparatus 80 is configured to regenerate the treatment section 21 by releasing the substances removed from the aqueous solution in the treatment mode. In the present embodiment, the regeneration section 40 is shown in FIGS. 7 and 8. The regeneration section 40 comprises the ion generating body 81. The ion generating body 81 comprises the interposed water-splitting membrane. The arrangement of the interposed water-splitting membrane is identical to that described above with reference to FIGS. 5 and 6, and so a detailed description will be omitted. The water-splitting membrane of the ion generating body 81 comprises an anion exchange membrane 82 and a cation exchange membrane 83. Although an isolation arrangement is omitted, it will be understood that the decalcifying apparatus 80 may have an isolating arrangement, for instance a check valve, a switchable valve or pump.

The interposed water-splitting membrane forming the ion generating body 81 is receivable between the first and second electrode arrangements 27, 28 in both the treatment and regeneration modes. The water-splitting membrane of the ion generating body 81 separates the treatment section 21 into a first cell space 46 and a second cell space 47. The water-splitting membrane is orientated so that the anion exchange membrane 82 faces the first electrode arrangement 27, and the cation exchange membrane 83 faces the second electrode arrangement 28.

When the decalcifying apparatus 80 is in the treatment mode, as shown in FIG. 7, the first electrode arrangement 27 is provided with a negative electric charge (−) and the second electrode arrangement 28 is provided with a positive electric charge (+). The regeneration section 40 is received between the first and second electrode arrangements 27, 28.

When a potential difference is applied between the first and second electrode arrangements 27, 28, cations, Na⁺, Ca²⁺ (identified by arrows 86, 87 respectively) are attracted to the first electrode arrangement 27, acting as a cathode. Anions, Cl⁻, HCO₃⁻ (identified by arrows 88, 89 respectively) are attracted to the second electrode arrangement 28, acting as an anode. In the present arrangement, the fixed ion generating body 81 separating the first and second cell spaces 46, 47, will substantially block cations and anions. Therefore during the treatment mode, cations originating predominantly from the first cell space 46 are able to reach the first electrode arrangement 27, and will be adsorbed from the aqueous solution onto the surface of the first electrode arrangement 27. Anions, originating predominantly from the second cell space 47 are able to reach the second electrode arrangement 28, and will be adsorbed from the aqueous solution onto the surface of the second electrode arrangement 28. In an alternative embodiment, two or more treatment sections 21 are aligned in sequence. In such an arrangement, the rate at which the aqueous solution is treated to achieve the desired level of deionisation is maximised. In the present arrangement, a high potential difference, for example in the range of 1V to 40V, is applied during the treatment mode due to the presence of the fixed ion generating body 81 during the treatment mode.

Once the aqueous solution has been treated for a predetermined period of time, the level of cations (Na⁺, Ca²⁺) and anions (Cl⁻, HCO₃⁻) are reduced to a desired level. The aqueous solution in the chamber 22 has then been treated. The sodium and calcium ions (Na⁺, Ca²⁺) are collected on the first electrode arrangement 27 and the chloride and bicarbonate ions (Cl⁻, HCO₃⁻) are collected on the second electrode arrangement 28.

The user uses the switching arrangement to switch between the first configuration, that is the treatment mode, and the second configuration, that is the regeneration mode.

When the decalcifying apparatus 80 is operated to reverse the polarity of the first and second electrode arrangements 27, 28 in the regeneration mode, the first electrode arrangement 27 has a high potential or positive charge (+). The second electrode arrangement 28 has a low potential or negative charge (−). In the regenerating mode, potential differences in the range of 1V to 40V are typically applied.

In the second configuration, regeneration mode, the first electrode arrangement 27 acts as a anode repelling the sodium and calcium cations, Na⁺ (identified by arrow 91 in FIG. 8) and Ca²⁺ (identified by arrow 92 in FIG. 8). Therefore, the unwanted substances are expelled from the first electrode arrangement 27 into the small volume of aqueous solution in the treatment space 24. The second electrode arrangement 28 acts as a cathode repelling the chloride and bicarbonate anions, Cl⁻ (identified by arrow 93 in FIG. 8) and HCO₃⁻ (identified by arrow 94 in FIG. 8). Further, reference 95 indicates released OH⁻ and reference 96 indicates released H⁺. Therefore, the unwanted substances are expelled from the second electrode arrangement 28 into the small volume of aqueous solution in the treatment space 24. The cations (Na⁺, Ca²⁺) released by the first electrode arrangement 27 are unable to overcome the anion exchange membrane 82 and pass through the water-splitting membrane to the second electrode arrangement 28. The anions (CL, HCO₃⁻) released by the second electrode arrangement 28 are unable to overcome the cation exchange membrane 83 and reach the first electrode arrangement 27.

In the regeneration mode, the applied electrode polarity enables the water-splitting membrane of the ion generating body 81 to split the water molecules (H₂O) into hydrogen cations (H⁺) and hydroxide anions (OH⁻) by auto-ionisation. Water molecules are split at the junction 84 of the water-splitting membrane. The water (H₂O) at the junction 84 between the anion exchange and cation exchange membranes 82, 83 are partially dissociated into hydrogen (H⁺) and hydroxide (OH⁻) ions. Water molecules (H₂O) are transported to the junction 84 of the water-splitting membrane by diffusion. The hydroxide anions (OH⁻) pass through the anion exchange membrane 82 under the influence of the electric field. The hydroxide anions (OH⁻) are attracted towards the first electrode arrangement 27, acting as an anode, into the first cell space 46. In the first cell space 46, the hydroxide anions (OH⁻) react with the cations (Na⁺, Ca²⁺) desorbed from the surface of the first electrode arrangement 27 to form a precipitate and alkaline solution. The hydrogen cations (H⁺) pass through the cation exchange membrane 83 under the influence of the electric field. The hydrogen cations (H⁺) are attracted towards the second electrode arrangement 28, acting as a cathode, into the second cell space 47. In the second cell space 47, the hydrogen cations (H⁺) react with the anions (Cl⁻, HCO₃⁻) desorbed from the surface of the second electrode arrangement 28 to form an acidic solution. Use of a water-splitting membrane provides for water to be decomposed by auto-ionisation and not electrolysis and so the formation of chlorine gas (Cl₂) is prevented. The formation of hydrogen (H₂) and oxygen (O₂) gas produced by the electrolysis of water is also prevented.

With the above embodiments, the arrangement of the decalcifying apparatus 80 is simplified because it is not necessary to move the regeneration section 40 and the electrode arrangements 27, 28 relative to each other. Therefore, reliability of operation may be improved and manufacture may be simplified.

In another alternative embodiment, the water-splitting membrane as described in any of the above described embodiments comprises an exchange membrane flow spacer (not shown) disposed between, and configured to space, the anion exchange membrane 82 and the cation exchange membrane 83. The exchange membrane flow spacer provides a space for untreated water to flow between the exchange membranes 82, 83. In the treatment mode, the exchange membrane flow spacer allows for anions in the first cell space 46 to cross the anion exchange membrane 82 and be transported by the flow inside the exchange membrane flow spacer towards the chamber 22. And, similarly for cations in the second cell space 47 to cross the cation exchange membrane 83 and be transported by the flow inside the exchange membrane flow spacer towards the chamber 22. The advantage of this exchange membrane flow spacer is that ions in the water stream are able to contribute to the conductivity of the aqueous solution which lowers the voltage drop over the water-splitting membrane.

In another alternative embodiment, the water-splitting membrane as described in any of the above described embodiments comprises a proton conducting material, for example Nafion, disposed between the anion exchange membrane 82 and the cation exchange membrane 83. The proton conducting material facilitates the transport of hydrogen ions between the anion exchange membrane 82 and the cation exchange membrane 83. This helps to lower the voltage drop over the water-splitting membrane. However, also part of the aqueous solution may be used as proton conducting material. For instance, in such instance there may be three volumes (and/or flows) of aqueous solution.

In another alternative embodiment, the ion generating body 81 fixedly mounted in the treatment space 24 comprises an interposed electrolysis electrode, as described above with reference to FIGS. 3 and 4, instead of a water-splitting membrane. Therefore, in the first operating condition, that is the treatment mode, by electrolysis hydrogen cations will be generated from the ion generating body 81 into the first cell space 46, forming an acidic solution in the first cell space 46. Hydroxide anions will be generated into the second cell space 47, forming an alkaline solution in the second cell space 47. The acidic and alkaline solutions will then be able to mix inside the chamber 22, to form a substantially neutral and partly de-ionized solution. An advantage of this embodiment is that high electrical currents may be achieved through the first and second electrode arrangements 27, 28 to maximise the rate of treatment.

In another embodiment, the first and second electrode arrangements 27, 28 are formed from a flexible material, for instance a woven cloth of active carbon fibres. The ion generating body 81 may also be formed from a flexible material, for example, a thin electrode sheet or stack of thin anion and cation exchange membranes. In one embodiment, the first and second cell spaces 46, 47 each include an electrode arrangement flow spacer (not shown), for example a diamond shaped mesh of polypropylene. The stack including the first electrode arrangement 27, the electrode arrangement flow spacer, the ion generating body 81, the electrode arrangement flow spacer, and the second electrode arrangement 28 may have a spiral arrangement, such that the treatment section 21 is cylindrically shaped. This arrangement helps to minimise the size of the decalcifying apparatus 80.

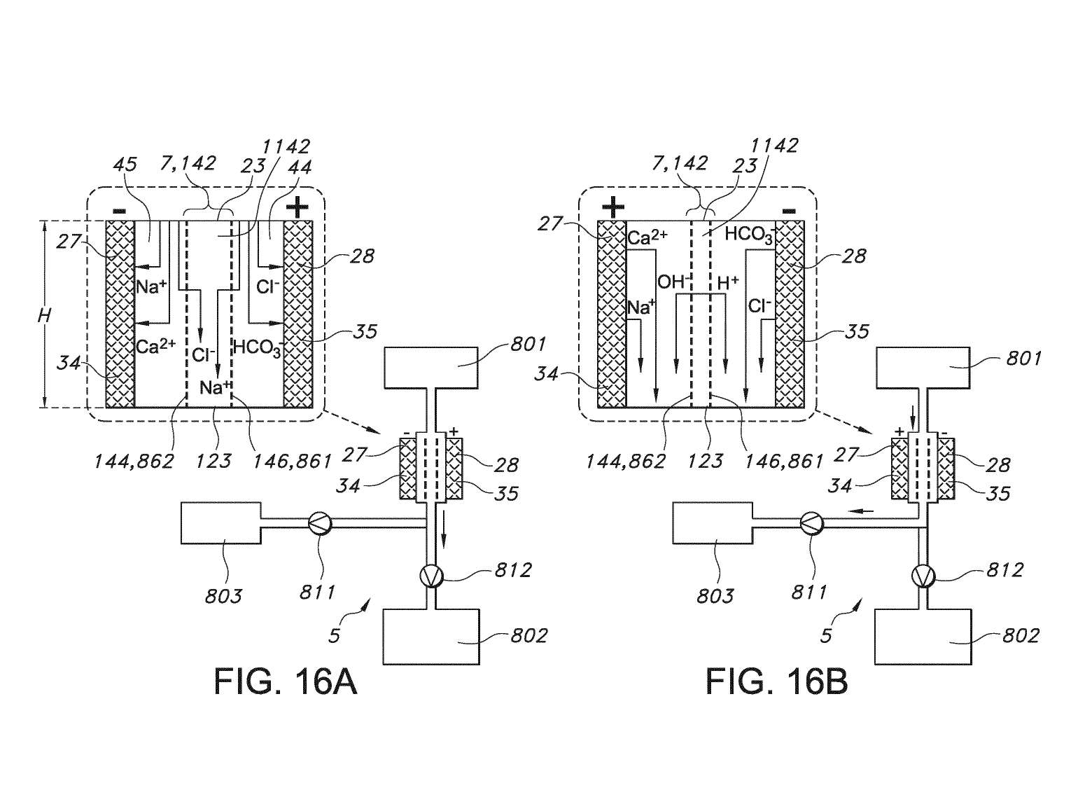

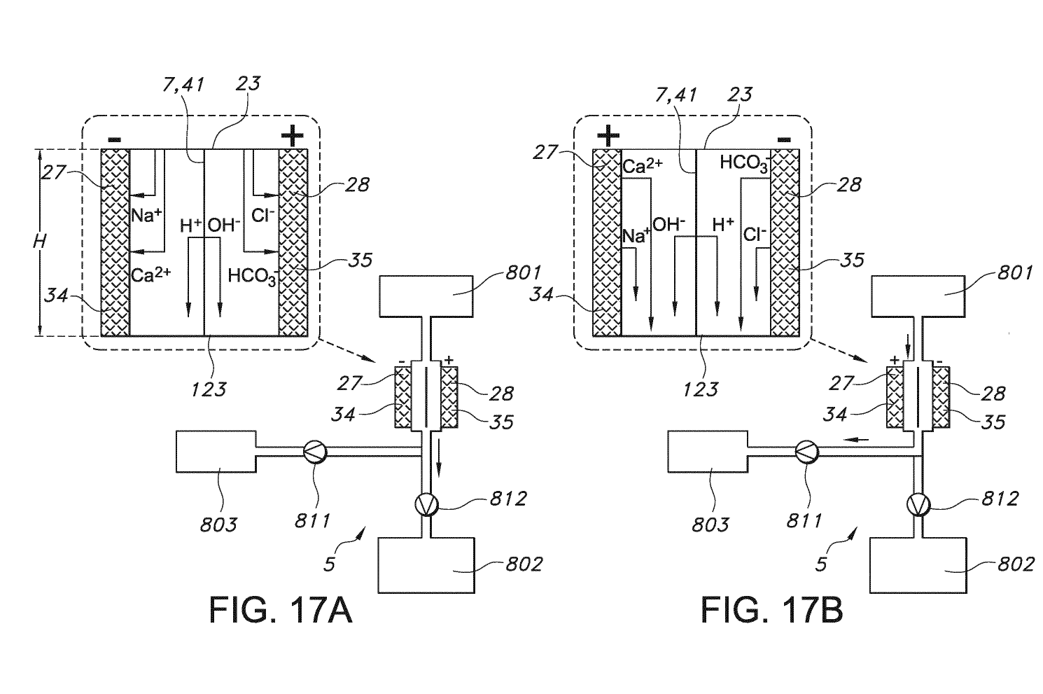

Referring now to FIGS. 9 and 10, an alternative embodiment of a decalcifying apparatus 5, here indicated as decalcifying apparatus 100, is shown. The decalcifying apparatus 100 shown in FIGS. 9 and 10 is generally the same as the embodiments of the decalcifying apparatus described above, and so a detailed description will be omitted herein. Furthermore, features and components of the decalcifying apparatus 100 of the present embodiment corresponding to features and components of the decalcifying apparatus described above will retain the same terminology and reference numerals. However, in the present embodiment the configuration of the treatment section 21 differs.

In the embodiment shown in FIGS. 9 and 10, the treatment section 21 has a generally cylindrical arrangement. The electrolytic cell section 26 has an arcuate profile. The first electrode arrangement 27 and the second electrode arrangement 28 are arced. The first electrode arrangement 27 comprises an inner first electrode 27a and an outer first electrode 27b. The second electrode arrangement 28 is disposed between the inner first and second electrodes 27a, 27b. An inner treatment space 24a is defined between the inner first electrode 27a and the second electrode arrangement 28. An outer treatment space 24b is defined between the outer first electrode 27b and the second electrode arrangement 28. The inner and outer treatment spaces 24a, 24b form the treatment space 24.

A regeneration section 40 is receivable in the treatment space 24. The regeneration section 40 is arcuate. The regeneration section 40 comprises an inner ion generating body 101 and an outer ion generating body 102. The inner and outer ion generating bodies 101, 102 are arcuate.

The treatment section 21 and regeneration section 40 are arced about the same longitudinal axis. The regeneration section 40 is rotatable about the longitudinal axis relative to the treatment section 21.

The inner ion generating body 101 is rotatable to be received in the inner treatment space 24a. Therefore, the inner ion generating body 101 is receivable between the inner first electrode 27a of the first electrode arrangement 27 and the second electrode arrangement 28. The outer ion generating body 102 is rotatable to be received in the outer treatment space 24b. Therefore, the outer ion generating body 102 is receivable between the outer first electrode 27b of the first electrode arrangement 27 and the second electrode arrangement 28.

The arcuate arrangement helps to minimise the size of the decalcifying apparatus 100.

In the present arrangement, each of the inner and outer ion generating bodies 101, 102 comprises an interposed electrolysis electrode. Alternatively, each of the inner and outer ion generating bodies 101, 102 comprises a water-splitting membrane (not shown). The interposed electrolysis electrode and the water-splitting membrane are generally identical to those described above in reference to FIGS. 3 to 8, except that they are arcuate, and so a detailed description will be omitted herein.

A switching arrangement (not shown) provides for moving the decalcifying apparatus 100 between the treatment and regeneration modes. In the treatment mode, the inner and outer ion generating bodies 101, 102 are rotated to be retracted from the treatment space 24. In the regeneration mode, the inner and outer ion generating bodies 101, 102 are rotated to be received in the treatment space 24. The switching arrangement comprises a knob (not shown) or the like mounted to the regeneration section 40 acting as a user input. Alternatively, a motor may be used which is operated by the controller. Therefore, when the user rotates the knob, the inner and outer ion generating bodies 101, 102 are rotated into position in between the first and second electrode arrangements 27, 28.

Operation of the decalcifying apparatus 100 is generally the same as the decalcifying apparatus described above and so a detailed description will be omitted herein. Reversing the polarity of the first and second electrode arrangements 27, 28 may be actuated in response to actuating the knob, acting as a user input.

Although in the embodiments described herein the decalcifying apparatus comprises a chamber for aqueous solution, it will be understood that the chamber may be omitted. For example, the decalcifying apparatus may be a unit which is receivable in a chamber for aqueous solution, or may be a unit which is disposed in-line on or in a pipe along which an aqueous solution flows. The pipe may extend to a chamber or may form a chamber.

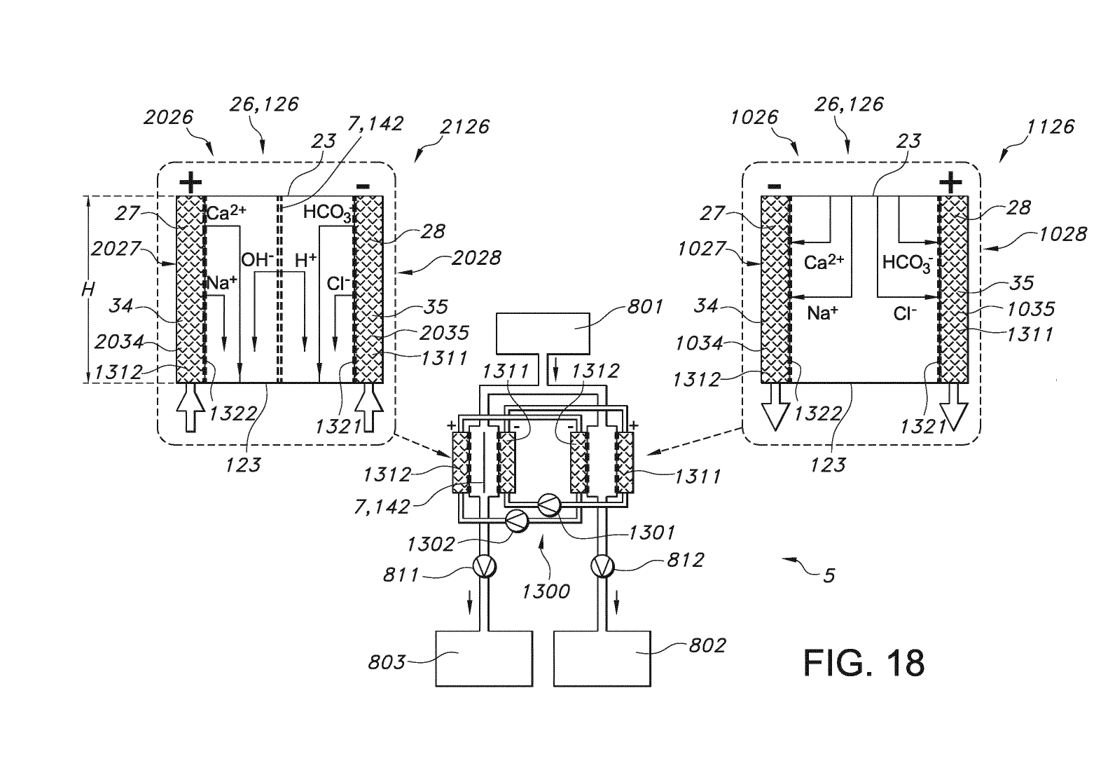

FIGS. 11a-11b, 12a-12b, 13, 14a-14b, 15a-15b, 16a-16b, 17a-17b, and 18 evaluate some alternative apparatus (11a-11b, 12a-12b, 13, 14a-14b, 15a-15b) as well as the apparatus as defined herein (16a-16b, 17a-17b; 18).

FIGS. 11a-11b schematically show the purification mode (11a) and the regeneration mode (11b). Electrosorption electrodes 34,35 are applied. In the regeneration mode, no potential difference is applied and no ion generating body is used. The ions adsorbed in the purification mode are released in the regeneration mode, but calcification may happen inside the electrolytic cell 126 during regeneration. Reference 801 indicates the input of the aqueous solution. References 802 and 803 indicated the output and waste output, respectively. References 811 and 812 indicate pumps or other devices to generate a flow, with here reference 811 e.g. indicated a drain pump and reference 812 indicating an output or application pump.

FIGS. 12a-12b differs from FIGS. 11a-11b in that ion exchange (IEX) membranes are associated with the electrosorption electrodes 34,35. The respective membranes are indicated with references 861 (especially cation ion selective membrane, assuming a negative potential of the corresponding electrosorption electrode 34 during the purification mode) and 862 (especially an anion selective membrane, assuming a positive potential of the corresponding electrosorption electrode 35 during the purification mode). During regeneration, the potential difference may be reversed. The ions adsorbed in the purification mode are released in the regeneration mode, but calcification may happen inside the electrolytic cell 126 during regeneration.

FIG. 13 schematically depicts another option, where no electrosorption electrodes are applied, but normal electrodes 871 (negative potential during purification) and 872 (positive potential during purification), such as e.g. Pt plates or rods. Further, ion exchange membranes 861,862 are applied, but remote from the electrodes 871,872, and with a space(r) in between the ion exchange membranes 861,862. Such configuration may be used as continuous process, but a disadvantage is a high waste flow. Note that only the central part between the ion exchange membranes provides the purified aqueous solution

FIGS. 14a-14b schematically depict essentially the same embodiment as schematically depicted in FIGS. 12a-12b, with the exception that not electrosorption electrodes are applied, but normal electrodes 871 (negative potential during purification) and 872 (positive potential during purification), such as e.g. Pt plates or rods. In such embodiment, the ions are not stored in the electrosorption electrodes, but some ions might be stored in the ion exchange membranes. However, those have a limited adsorption capacity, much lower than of electrosorption electrodes. Further, also calcification may happen inside the electrolytic cell 126 during regeneration.

FIGS. 15a-15b schematically depict essentially the same embodiment as schematically depicted in FIGS. 14a-14b, with the exception that the ion exchange membranes 861,862 are now remote from the electrodes. There is no space(r) between the ion exchange membranes 861,862. However, those have a limited adsorption capacity, much lower than of electrosorption electrodes. Further, gas formation (oxygen, hydrogen, and chlorine gas) may occur.

Hence, as the examples of FIGS. 11a-15b provide suboptimal solutions, the present invention proposes an alternative apparatus, having advantages over these systems. FIGS. 16a-16b schematically depict an embodiment according to the invention, such as similar to those of for instance FIGS. 5-8. In this schematically depicted embodiment, by way of example the ion exchange membranes 861,862 are stationary, and also available in the purification mode. Here, the ion exchange membranes 861,862 are configured as ion generating body, as during regeneration, the ion exchange membranes split water. Hence, here, the water splitting membrane 142 is used. Herein, (specific) embodiments of the water splitting membrane 142 are also indicated with references 61,81. Advantages of this embodiment are that there is no calcification during cell regeneration and there is no gas formation. Further, the waste volume may be much smaller, as during regeneration flow may be low (or zero). Only for drawing purposes the inter membrane distance in FIG. 16a is larger than in FIG. 16b. Further, note that when the water-splitting membrane is used, the water-splitting membrane may provide a third volume (or exchange membrane flow spacer), indicated with reference 1142, between the respective two cell parts. Here, the ion exchange membranes 861,862 are also indicated as ion exchange membranes 146,144, with the ion exchange membrane 146,861 being cation selective, and with the ion exchange membranes 144,862 being an ion selective. The central volume may be in fluidic contact with the output 802 (or treated aqueous solution selection) during purification and may be in fluidic contact with the waste output 803 during regeneration. Herein, (specific) embodiments of the anion exchange membrane 144 are also indicated with references 62,82. Herein, (specific) embodiment of the cation exchange membrane 146 are also indicated with references 63,83.

The height of the electrosorption electrodes 34,35 and the ion generating body 7 is indicated with reference H. The schematically shown embodiment of the apparatus 5 show that these all have substantially the same height.

FIGS. 17a-17b schematically depict essentially the same embodiment as schematically depicted in FIGS. 16a-16b, with the exception that instead of the ion exchange membranes 861,862 (i.e. the ion generating body 7) configured between the electrosorption electrodes 34,35, now the ion generation body 7 is an electrode (here a floating electrode). This embodiment may have the same advantages as the former embodiment, though some gas formation may occur. A further advantage of this embodiment is that the electrolytic cell may be extremely thin.

Herein, the (specific) embodiment of the ion generating body are also indicated with references 41, 61, 81, 101, 102.

Note that all embodiments according to the invention are described and schematically depicted in relation to decalcifying apparatus 5 having a single electrolytic cell unit. However, the invention is not limited to such embodiments. In contrast, the decalcifying apparatus may include a plurality of such cells, including tubing and pumps, thereby allowing a continuous purification of the aqueous solution, while some cells may purify, while others regenerate, while at a later moment this may be reversed, while thus still producing a purified aqueous solution.

FIG. 18 schematically depicts a further embodiment of the decalcifying apparatus 5. The apparatus 5 comprises a first electrolytic cell unit 1126 and a second electrolytic cell unit 2126.

The first electrolytic cell unit 1126 comprises a first electrolytic cell section 1026 configured to receive at least part of an aqueous solution. Further, the first electrolytic cell section comprises a first electrode arrangement 1027 and a second electrode arrangement 1028, wherein the first electrode arrangement 1027 comprises a first electrosorption electrode 1034 and wherein the second electrode arrangement 1028 comprises a second electrosorption electrode 1035.

Likewise, the second electrolytic cell unit 2126 comprises a second electrolytic cell section 2026 configured to receive at least part of an aqueous solution. The second electrolytic cell section comprises a first electrode arrangement 2027 and a second electrode arrangement 2028. The first electrode arrangement 2027 comprises a first electrosorption electrode 2034 and wherein the second electrode arrangement 2028 comprises a second electrosorption electrode 2035.

References 1126 and 2126 are used to indicate different electrolytic cell units 126. References 1027 and 2027, and references 1028 and 2028 are used to indicated different (first and second, respectively) electrode arrangements. Likewise, references 1026 and 2026 are used to indicate different electrolytic cell sections 26. Likewise this may apply to other references.

The decalcifying apparatus is especially configured to operate with the first electrolytic cell unit 1126 in a first operating condition for removing ions from aqueous solution, and the decalcifying apparatus being configured to operate with the second electrolytic cell unit 2126 in a second operating condition for regenerating the ions into aqueous solution, wherein the ion generating body 7 (see also above), especially a water splitting membrane 142, as here schematically depicted, is interposed in the second electrolytic cell section 2026 in the second operating condition.

Yet further, the first electrode arrangements 1027,2027 and the second electrode arrangements 1028,2028 comprise flowable electrosorption material 1311,1312 in operation separated from the aqueous solution by membranes 1321,1322. The decalcifying apparatus further comprises a flowable electrosorption material circulation system 1300 configured to circulate the flowable electrosorption material between the electrode arrangements 1027,1028,2027,2028 of the first electrolytic cell unit 1126 and the second electrolytic cell unit 2126. Here, by way of example the flowable electrosorption material circulation system 1300 comprises two closed circuits, one with a first pump or other flow inducing means 1301 configured to circulate first flowable electrosorption material 1311, and a second pump or other flow inducing means 1302 configured to circulate second flowable electrosorption material 1312. Note that the flowable electrosorption materials 1311,1312 may be identical (but may flow in separate loops).

With such embodiment, again there is no decalcification during regeneration. For the continuous mode architecture of FIG. 18 the preferred embodiment of the ion generating body 7 is a water splitting membrane consisting of a cation exchange membrane and an anion exchange membrane in direct contact. So preferably the water splitting membrane does not contain a flow spacer between both ion selective membranes. This is different from the batch-mode architecture of FIG. 16a,b where a flow spacer is beneficial to prevent accumulation of ions during purification mode. However, alternatively, instead of the water splitting membrane 142 also an (interposed) electrode 41 might be applied as embodiment of the ion generating body 7.

The function of the membranes 1321,1322 is to keep the flowable electrosorption material separated from the aqueous solutions, but allow for ion transport between them. The membranes 1321 and 1322 are microporous polymer sheets with openings of sub micrometer size, and preferably nanometer size. Optionally these polymers may contain ion exchange functional groups. For example, the membrane 1322 at the first electrode arrangement 1027 of the first electrolytic cell unit 1126 may contain sulfonic acid group (SO₃⁻), carboxyl group (COO⁻) or phosphoric acid group (PO₄⁻) capable of exchanging cations. Likewise the membrane 1322 at the first electrode arrangement 2027 of the second electrolytic cell unit 2126. And for example, the membrane 1321 at the second electrode arrangement 1028 of the first electrolytic cell unit 1126 may contain primary, secondary, tertiary or quaternary ammonium groups capable of exchanging anions. Likewise for membrane 1321 at the second electrode arrangement 2028 of the second electrolytic cell unit 2126.

Hence, in an embodiment the invention provides (also) a continuous flow-electrode system comprising a flow anode containing a flowable anode active material and a flow cathode containing a flowable cathode active material. Especially, the anode comprises an anode collector; an anode separation layer; an anode flow channel formed between the anode collector and the anode separation layer; and the anode active material flowing through the anode flow channel, and/or the cathode comprises a cathode collector; a cathode separation layer; a cathode flow channel formed between the cathode collector and the cathode separation layer; and the cathode active material flowing through the cathode flow channel. Further, in an embodiment the anode separation layer is a microporous insulation separation membrane or an anion-exchange (conductive) membrane and/or the cathode separation layer is a microporous insulation separation membrane or a cation-exchange (conductive) membrane. Yet, in a further embodiment the anode active material or the cathode active material is mixed with an electrolyte to form an active material in a slurry phase. Also, in an embodiment the anode active material and the cathode active material includes the same material. Further, in an embodiment the separation layer is a microporous insulation separation membrane, and the anode active material and/or the cathode active material is micro-capsulated.

The term “substantially” herein, such as in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention further applies to a device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Furthermore, some of the features can form the basis for one or more divisional applications.

1. A decalcifying apparatus for decalcifying an aqueous solution comprising
an electrolytic cell section configured to receive the aqueous solution,
the electrolytic cell section comprising a first electrode arrangement and a second electrode arrangement, wherein the first electrode arrangement comprises a first electrosorption electrode and wherein the second electrode arrangement comprises a second electrosorption electrode;
an ion generating body, wherein the ion generating body is not electrically connected,
the decalcifying apparatus being configured to operate in a first operating condition for removing ions from the aqueous solution,
and the decalcifying apparatus being configured to operate in a second operating condition for regenerating the ions into aqueous solution, wherein the ion generating body is interposed in the electrolytic cell section in the second operating condition.

2. The decalcifying apparatus according to claim 1, wherein the ion generating body is configured to generate hydrogen cations and hydroxide anions, to balance the charge of the ions regenerated from both first and second electrode arrangements, and wherein the ion generating body is configured to block recombination between regenerated ions from first and second electrode arrangements inside the electrolytic cell during the second operating condition.

3. The decalcifying apparatus according to claim 1, wherein the decalcifying apparatus is configured to operate the first operation condition and the second operation condition one or more of (a) spatially and (b) temporarily separated from each other.

4. The decalcifying apparatus according to claim 1, wherein the ion generating body is a water-splitting membrane.

5. The decalcifying apparatus according to claim 1, wherein the ion generating body is an interposed electrode.

6. The decalcifying apparatus according to claim 4, wherein the water-splitting membrane comprises an anion exchange membrane and a cation exchange membrane configured to block ions desorbed from the respective facing first and second electrode arrangements in the second operating condition.

7. The decalcifying apparatus according to claim 6, wherein the water-splitting membrane further comprises an exchange membrane flow spacer disposed between the anion exchange membrane and the cation exchange membrane.

8. The decalcifying apparatus according to claim 6, wherein the water-splitting membrane further comprises a proton conducting material between the anion exchange membrane and the cation exchange membrane.

9. The decalcifying apparatus according to claim 5, wherein the surface area of the interposed electrode is less than the surface area of each of the first electrode arrangement and second electrode arrangement.

10. The decalcifying apparatus according to claim 1, further comprising an isolating arrangement which, in the second configuration, is configured to fluidically isolate the electrolytic cell section from a treated aqueous solution section for receiving treated aqueous solution.

11. The decalcifying apparatus according to claim 10, wherein the isolating arrangement is configured to fluidically isolate the first electrode arrangement from the second electrode arrangement in the second operating condition, and wherein the isolating arrangement is on the ion generating body.

12. The decalcifying apparatus according to claim 1, wherein the ion generating body is configured to be absent from the electrolytic cell section in the first operating condition, or wherein the ion generating body is interposed in the electrolytic cell section in the first operating condition.

13. The decalcifying apparatus according to claim 1, configured, in the first operating condition, to apply a voltage between the first electrode arrangement, having a low potential, and the second electrode arrangement, having a high potential, to attract the ions to the electrode arrangements and remove the ions from the aqueous solution, and configured, in the second operating condition, to reverse the polarity to apply a voltage between the first and second electrode arrangements with the potentials reversed such that the first electrode arrangement has a high potential and the second electrode arrangement has a low potential to regenerate the ions removed from the aqueous solution.

14. The decalcifying apparatus according to claim 1, comprising an electrolytic cell unit comprising the first electrode arrangement and the second electrode arrangement, further comprising an inlet for receiving said aqueous solution and an outlet for releasing said aqueous solution, wherein the electrolytic cell unit is configured as flow-through unit.

15. The decalcifying apparatus according to claim 1, comprising a first electrolytic cell unit and a second electrolytic cell unit;
wherein the first electrolytic cell comprises:
a first electrolytic cell section configured to receive at least part of an aqueous solution,
the first electrolytic cell section comprising a first electrode arrangement and a second electrode arrangement, wherein the first electrode arrangement comprises a first electrosorption electrode and wherein the second electrode arrangement comprises a second electrosorption electrode;
wherein the second electrolytic cell unit comprises:
a second electrolytic cell section configured to receive at least part of an aqueous solution,
the second electrolytic cell section comprising a first electrode arrangement and a second electrode arrangement, wherein the first electrode arrangement comprises a first electrosorption electrode and wherein the second electrode arrangement comprises a second electrosorption electrode, and
the decalcifying apparatus being configured to operate with the first electrolytic cell unit in a first operating condition for removing ions from aqueous solution,
the decalcifying apparatus being configured to operate with the second electrolytic cell unit in a second operating condition for regenerating the ions into aqueous solution, wherein the ion generating body is interposed in the second electrolytic cell section in the second operating condition;
wherein the first electrode arrangements and the second electrode arrangements comprise flowable electrosorption material in operation separated from the aqueous solution by membranes,
wherein the decalcifying apparatus further comprises a flowable electrosorption material circulation system configured to circulate the flowable electrosorption material between the electrode arrangements of the first electrolytic cell unit and the second electrolytic cell unit.

16. A domestic appliance comprising a decalcifying apparatus according to claim 1.

17. A method of decalcifying an aqueous solution having a first operating condition for removing ions from aqueous solution and a second operating condition for regenerating the ions into aqueous solution, the first operating condition comprising:
(a) introducing an aqueous solution, and,
(b) applying a voltage between a first electrode arrangement; having a low potential, and a second electrode arrangement, having a high potential, in the aqueous solution to attract the ions to the electrode arrangements and remove the ions from the aqueous solution;
the second operating condition in which an ion generating body is interposed between the first and second electrode arrangements to define a first cell and a second cell, each cell containing an oppositely charged first and second electrode arrangement, wherein the ion generating body is not electrically connected, the second operating condition comprising:
(c) applying a voltage between the first and second electrode arrangements with the potentials reversed such that the first electrode arrangement has a high potential and the second electrode arrangement has a low potential to regenerate the ions removed from the aqueous solution in the first operating condition, and
(d) removing the resulting waste aqueous solution from the electrolytic cell section,
wherein the first electrode arrangement comprises a first electrosorption electrode and wherein the second electrode arrangement comprises a second electrosorption electrode.

18. The method according to claim 17, wherein a decalcifying apparatus is applied comprising an electrolytic cell unit comprising said first electrosorption electrode and said second electrosorption electrode, and wherein the first operating condition and second operating condition are alternated, and are executed in the same electrolytic cell unit.

19. The method according to claim 16, wherein the ion generating body is only interposed between the first and second electrode arrangements during the second operation condition.

20. The method according to claim 16, wherein the ion generating body is interposed between the first and second electrode arrangements during both the first operation condition and the second operation condition.

21. The method according to claim 15, wherein the decalcifying apparatus is applied, and wherein the method comprises applying the first operation condition and second operation condition at the same time but in different electrolytic cell units with said decalcifying apparatus.
